(19) United States
(12) Patent Application Publication
(10) Pub. No.: US 2016/0014667 A1
(43) Pub. Date: Jan. 14, 2016

(54) APPARATUS, SYSTEM AND METHOD OF CELLULAR NETWORK COMMUNICATIONS CORRESPONDING TO A NON-CELLULAR NETWORK

(71) Applicants: Alexander SIROTKIN, Giv'on Hachadasha (IL); Hyung-Nam CHOI, Hamburg (DE); Nageen HIMAYAT, Fremont, CA (US)

(72) Inventors: Alexander Sirotkin, Giv'on Hachadasha (IL); Hyung-Nam Choi, Hamburg (DE); Nageen Himayat, Fremont, CA (US)

(21) Appl. No.: 14/772,523

(22) PCT Filed: Dec. 27, 2013
(86) PCT No.: PCT/US2013/077906

§ 371 Date: Sep. 3, 2015

Related U.S. Application Data
(60) Provisional application No. 61/808,597, filed on Apr. 4, 2013.

(51) Int. Cl. H04W 36/30; H04W 24/08; H04W 72/04; H04W 76/04

(52) U.S. Cl. CPC H04W 36/30; H04W 76/046; H04W 24/08; H04W 72/0486; H04W 84/12

(57) ABSTRACT

Some demonstrative embodiments include devices, systems and/or cellular network communications corresponding to a non-cellular network. For example, a node B may include a radio to communicate with a User Equipment (UE) over a cellular link; an Interface Unit b (Iub) to communicate with a Radio Network Controller (RNC), the Iub to receive from the RNC a trigger indication to indicate the UE is to initiate or terminate offloading to a Wireless Local Area Network (WLAN); and a controller to control the radio to transmit a trigger message to the UE based on the trigger indication.

### CROSS REFERENCE

This application claims the benefit of and priority from US Provisional Patent Application No. 61/808,597 entitled “Advanced Wireless Communication Systems and Techniques”, filed Apr. 4, 2013, the entire disclosure of which is incorporated herein by reference.

### TECHNICAL FIELD

Some embodiments described herein generally relate to cellular network communications corresponding to a non-cellular network.

### BACKGROUND

A wireless communication device, e.g., a mobile device, may be configured to utilize multiple wireless communication technologies.

For example, a User Equipment (UE) device may be configured to utilize a cellular connection, e.g., a Universal Mobile Telecommunications System (UMTS) cellular connection, as well as a wireless-local-area-network (WLAN) connection, e.g., a Wireless-Fidelity (WiFi) connection.

The UE may be configured to automatically utilize a WiFi connection, for example, as long as a Wi-Fi signal received by the UE is strong enough.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a sequence diagram of communicating Wireless Local Area Network (WLAN) measurement information and access network selection of a User Equipment (UE), in accordance with some demonstrative embodiments.

FIG. 3 is a schematic flow-chart illustration of a method of cellular network communication corresponding to a non-cellular network, in accordance with some demonstrative embodiments.

FIG. 4 is a schematic illustration of a product, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, a tablet computer, a Smartphone device, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a cellular network, a cellular node, a Wireless Local Area Network (WLAN), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, vending machines, sell terminals, and the like.

Some embodiments may be used in conjunction with devices and/or networks operating in accordance with existing 3rd Generation Partnership Project (3GPP) and/or Long Term Evolution (LTE) specifications (including “3GPP TS 25.331: 3rd Generation Partnership Project; Technical Specification Group Radio Access Network; Radio Resource Control (RRC); Protocol specification (Release 10), V10.11.0”, March 2013) and/or future versions and/or derivatives thereof, devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012), and/or future versions and/or derivatives thereof, devices and/or networks operating in accordance with existing IEEE 802.16 standards (IEEE-Std 802.16, 2009 Edition, Air Interface for Fixed Broadband Wireless Access Systems; IEEE-Std 802.16e, 2005 Edition, Physical and Medium Access Control Layers for Combined Fixed and Mobile Operation in Licensed Bands; amendment to IEEE Std 802.16-2009, developed by Task Group m) and/or future versions and/or derivatives thereof, devices and/or networks operating in accordance with existing WirelessHD™ specifications and/or future versions and/or derivatives thereof, units and/or devices which are part of the above networks, and the like.

Some embodiments may be used in conjunction with one or more types of wireless communication signals and/or systems, for example, Radio Frequency (RF), Frequency-Division Multiplexing (FDM), Orthogonal FDM (OFDM), Single Carrier Frequency Division Multiple Access (SC-FDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wireless Fidelity (Wi-Fi), Wi-Max, ZigBee™, Ultra-Wideband (UWB), Global System for Mobile communication (GSM), second generation (2G), 2.5G, 3G, 3.5G, 4G, Fifth Generation (5G) mobile networks, 3GPP, Long Term Evolution (LTE) cellular system, LTE advance cellular system, High-Speed Downlink Packet Access (HSDPA), High-Speed Uplink Packet Access (HSUPA), High-Speed Packet Access (HSPA), HSPA+, Single Carrier Radio Transmission Technology (1×RTT), Evolution-Data Optimized (EV-DO), Enhanced Data rates for GSM Evolution (EDGE), and the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some demonstrative embodiments are described herein with respect to a Universal Mobile Telecommunications System (UMTS) cellular system. However, other embodiments may be implemented in any other suitable cellular network, e.g., a 3G cellular network, a 4G cellular network, an LTE network, a 5G cellular network, a WiMax cellular network, and the like.

Some demonstrative embodiments are described herein with respect to a WLAN system. However, other embodiments may be implemented in any other suitable non-cellular network.

Some demonstrative embodiments may be used in conjunction with a Heterogeneous Network (HetNet), which may utilize a deployment of a mix of technologies, frequencies, cell sizes and/or network architectures, e.g., including cellular, mmWave, and/or the like. In one example, the HetNet may include a radio access network having layers of different-sized cells ranging from large macrocells to small cells, for example, picocells and femtocells.

Other embodiments may be used in conjunction with any other suitable wireless communication network.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a dipole antenna, a set of switched beam antennas, and/or the like.

The term “cell”, as used herein, may include a combination of network resources, for example, downlink and optionally uplink resources. The resources may be controlled and/or allocated, for example, by a cellular node (also referred to as a “base station”), or the like. The linking between a carrier frequency of the downlink resources and a carrier frequency of the uplink resources may be indicated in system information transmitted on the downlink resources.

The phrase “access point” (AP), as used herein, may include an entity that includes a station (STA) and provides access to distribution services, via the Wireless Medium (WM) for associated STAs.

The term “station” (STA), as used herein, may include any logical entity that is a singly addressable instance of a medium access control (MAC) and a physical layer (PHY) interface to the WM.

The phrases “directional multi-gigabit (DMG)” and “directional band” (DBand), as used herein, may relate to a frequency band wherein the Channel starting frequency is above 56 GHz.

The phrases “DMG STA” and “mmWave STA (mSTA)” may relate to a STA having a radio transmitter, which is operating on a channel that is within the DMG band.

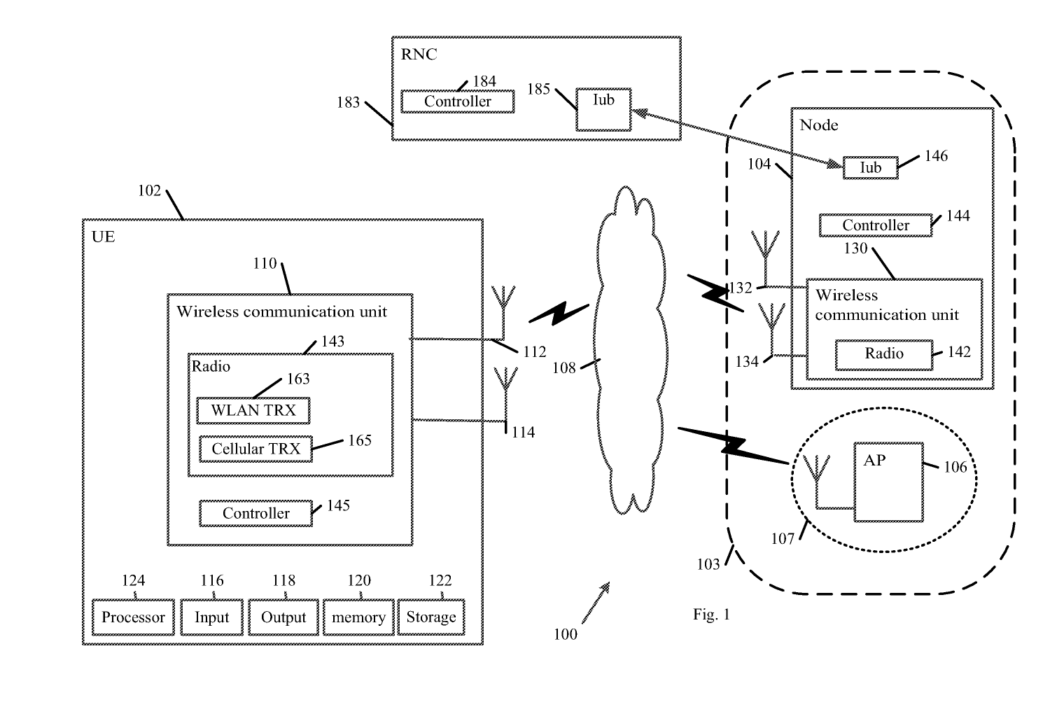

Reference is now made to FIG. 1, which schematically illustrates a block diagram of a system 100, in accordance with some demonstrative embodiments.

As shown in FIG. 1, in some demonstrative embodiments, system 100 may include one or more wireless communication devices capable of communicating content, data, information and/or signals via one or more wireless mediums 108. For example, system 100 may include at least one User Equipment (UE) 102 capable of communicating with one or more wireless communication networks, e.g., as described below.

Wireless mediums 108 may include, for example, a radio channel, a cellular channel, an RF channel, a Wireless Fidelity (WiFi) channel, an IR channel, and the like. One or more elements of system 100 may optionally be capable of communicating over any suitable wired communication links.

In some demonstrative embodiments, system 100 may include at least one cellular network 103, e.g., a cell controlled by a node 104.

In some demonstrative embodiments, system 100 may include a non-cellular network 107, for example, a WLAN, e.g., a Basic Service Set (BSS), managed by an Access Point (AP) 106.

In some demonstrative embodiments, non-cellular network 107 may at least partially be within a coverage area of node 104. For example, AP 106 may be within a coverage area of node 104.

In other embodiments, non-cellular network 107 may be outside of the coverage area of node 104. For example, AP 106 may be outside of the coverage area of node 104.

In some demonstrative embodiments, cell 103 may be part of a UMTS and node 104 may include a Node B. For example, node 104 may be configured to communicate directly with UEs within the coverage area of cell 103, e.g., including UE 102. Node 104 may communicate with the UEs, for example, using a Wideband Code Division Multiple Access (WCDMA) and/or Time Division Synchronous Code Division Multiple Access (TD-SCDMA) air interface technology.

In some demonstrative embodiments, node 104 may be controlled by a Radio Network Controller (RNC) 183, form example a UMTS RNC, e.g., as described below.

In some demonstrative embodiments, node 104 may include an Interface, for example, an Interface Unit b (Iub) 146, and RNC 183 may include an Iub 185, to communicate between RNC 183 and node 104.

In some demonstrative embodiments, Iub 185 and Iub 146 may communicate according to a Node-B Application Part (NBAP) signaling protocol.

In other embodiments, node 104 and RNC 183 may communicate via any other interface and/or using any other signaling protocol.

In other embodiments, node 104 and/or RNC 183 may be part of any other cellular network, e.g., an LTE network, node 104 may include any other functionality and/or may perform the functionality of any other cellular node, e.g., an Evolved Node B (eNB), a base station or any other node or device.

In some demonstrative embodiments, UE 102 may include, for example, a mobile computer, a laptop computer, a notebook computer, a tablet computer, an Ultrabook™ computer, a mobile internet device, a handheld computer, a handheld device, a storage device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a mobile phone, a cellular telephone, a PCS device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a video device, an audio device, an A/V device, a gaming device, a media player, a Smartphone, or the like.

In some demonstrative embodiments, UE 102, node 104 and/or AP 106 may include one or more wireless communication units to perform wireless communication between UE 102, node 104, AP 106 and/or with one or more other wireless communication devices, e.g., as described below. For example, UE 102 may include a wireless communication unit 110 and/or node 104 may include a wireless communication unit 130.

In some demonstrative embodiments, wireless communication units 110 and 130 may include, or may be associated with, one or more antennas. In one example, wireless communication unit 110 may be associated with at least two antennas, e.g., antennas 112 and 114, or any other number of antennas, e.g., one antenna or more than two antennas; and/or wireless communication unit 130 may be associated with at least two antennas, e.g., antennas 132 and 134, or any other number of antennas, e.g., one antenna or more than two antennas.

In some demonstrative embodiments, antennas 112, 114, 132 and/or 134 may include any type of antennas suitable for transmitting and/or receiving wireless communication signals, blocks, frames, transmission streams, packets, messages and/or data. For example, antennas 112, 114,132 and/or 134 may include any suitable configuration, structure and/or arrangement of one or more antenna elements, components, units, assemblies and/or arrays. For example, antennas 112, 114, 132 and/or 134 may include a phased array antenna, a dipole antenna, a single element antenna, a set of switched beam antennas, and/or the like.

In some embodiments, antennas 112, 114, 132 and/or 134 may implement transmit and receive functionalities using separate transmit and receive antenna elements. In some embodiments, antennas 112, 114, 132 and/or 134 may implement transmit and receive functionalities using common and/or integrated transmit/receive elements.

In some demonstrative embodiments, wireless communication unit 130 may include at least one radio 142 and/or wireless communication unit 110 may include at least one radio 143. For example, radios 142 and/or 143 may include one or more wireless transmitters, receivers and/or transceivers able to send and/or receive wireless communication signals, RF signals, frames, blocks, transmission streams, packets, messages, data items, and/or data.

In some demonstrative embodiments, radio 143 may include or perform the functionality of at least one WLAN radio 163 to communicate with WLAN 107, and at least one cellular radio 165, e.g., a UMTS radio, to communicate with node 104.

In some demonstrative embodiments, UE 102 may include at least one controller 145 to control communications performed by radio 143, RNC 183 may include one or more controllers to control communications performed by Iub 185, and/or node 104 may include at least one controller 144 to control communications performed by radio 142 and/or Iub 146, e.g., as described below. In some embodiments, controller 145 may be implemented as part of wireless communication unit 110 and/or controller 144 may be implemented as part of wireless communication unit 130. In other embodiments, controller 145 may be implemented as part of any other element of UE 102 and/or controller 144 may be implemented as part of any other element of node 104.

In some demonstrative embodiments, radios 142 and/or 143 may include a multiple input multiple output (MIMO) transmitters receivers system (not shown), which may be capable of performing antenna beamforming methods, if desired. In other embodiments, radios 142 and/or 143 may include any other transmitters and/or receivers.

In some demonstrative embodiments, radios 142 and/or 143 may include WCDMA and/or TD-SCDMA modulators and/or demodulators (not shown) configured to communicate downlink signals over downlink channels, e.g., between node 104 and UE 102, and uplink signals over uplink channels, e.g., between UE 102 and node 104. In other embodiments, radios 142 and/or 143 may include any other modulators and/or demodulators.

In some demonstrative embodiments, wireless communication unit 110 may establish a WLAN link with AP 106. For example, wireless communication unit 110 may perform the functionality of one or more STAs, e.g., one or more WiFi STAs, WLAN STAs, and/or DMG STAs. The WLAN link may include an uplink and/or a downlink. The WLAN downlink may include, for example, a unidirectional link from AP 106 to the one or more STAs or a unidirectional link from a Destination STA to a Source STA. The uplink may include, for example, a unidirectional link from a STA to AP 106 or a unidirectional link from the Source STA to the Destination STA.

In some demonstrative embodiments, UE 102, RNC 183, node 104 and/or AP 106 may also include, for example, one or more of a processor 124, an input unit 116, an output unit 118, a memory unit 120, and a storage unit 122. UE 102, RNC 183, node 104 and/or AP 106 may optionally include other suitable hardware components and/or software components. In some demonstrative embodiments, some or all of the components of one or more of UE 102, RNC 183, node 104 and/or AP 106 may be enclosed in a common housing or packaging, and may be interconnected or operably associated using one or more wired or wireless links. In other embodiments, components of one or more of UE 102, RNC 183, node 104 and/or AP 106 may be distributed among multiple or separate devices.

Processor 124 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 124 executes instructions, for example, of an Operating System (OS) of UE 102, RNC 183, node 104 and/or AP 106 and/or of one or more suitable applications.

Input unit 116 includes, for example, a keyboard, a keypad, a mouse, a touch-screen, a touch-pad, a track-ball, a stylus, a microphone, or other suitable pointing device or input device. Output unit 118 includes, for example, a monitor, a screen, a touch-screen, a flat panel display, a Cathode Ray Tube (CRT) display unit, a Liquid Crystal Display (LCD) display unit, a plasma display unit, one or more audio speakers or earphones, or other suitable output devices.

Memory unit 120 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 122 includes, for example, a hard disk drive, a floppy disk drive, a Compact Disk (CD) drive, a CD-ROM drive, a DVD drive, or other suitable removable or non-removable storage units. Memory unit 120 and/or storage unit 122, for example, may store data processed by UE 102, RNC 183, node 104 and/or AP 106.

In some demonstrative embodiments, UE 102 may be configured utilize a cellular connection, e.g., a UMTS cellular connection or any other cellular connection, to communicate with node 104, and a WLAN connection, e.g., a Wireless-Fidelity (WiFi) connection, a mmWave connection, a P2P connection, or any other WLAN connection, to communicate with AP 106.

In some demonstrative embodiments, one or more elements of system 100 may perform the functionality of a HetNet, which may utilize a deployment of a mix of technologies, frequencies, cell sizes and/or network architectures, for example, including cellular, WLAN, and/or the like.

For example, the HetNet may be configured to provide a service through a first wireless communication environment, e.g., a cellular network, and to maintain the service when switching to another communication environment, e.g., WLAN. The HetNet architecture may enable utilizing a mixture of wireless communication environments, e.g., a WLAN environment and a cellular environment, for example, to optimally respond to rapid changes in customer demand, reduce power consumption, reduce cost, increase efficiency and/or achieve any other benefit.

In one example, system 100 may utilize a Multi-tier, Multi-Radio Access Technology (Multi-RAT) Het-Net architecture, including a tier of small cells, e.g., pico, femto, relay stations, WiFi APs, and the like, overlaid on top of a macro cellular deployment to augment network capacity.

In another example, system 100 may utilize Multi-RAT small cells integrating multiple radios such as WiFi and 3GPP air interfaces in a single infrastructure device.

In other embodiments, system 100 may implement any other architecture and/or deployment.

In some demonstrative embodiments, utilizing the WLAN connection as a default connection, e.g., as long as UE 102 receives from AP 106 a strong enough signal, may result in an increase in the congestion of the WLAN, e.g., if a large number of UEs connect by default to the same AP, which in turn may result in a decrease of throughput over the WLAN connection between UE 102 and AP 106.

In some demonstrative embodiments, RNC 183, UE 102, node 104 and/or AP 106 may be configured to enable selective connection of UE 102 to the WLAN or the cellular network, for example, based on one or more criteria and/or parameters, e.g., as described in detail below.

In some demonstrative embodiments, the selective connection between UE 102 and node 104 or AP 106 may enable, for example, load balancing between the WLAN and the cellular network and/or any other improvement.

In some demonstrative embodiments, RNC 183, UE 102, node 104 and/or AP 106 may be configured to enable a network-centric (also referred to as “network controlled”) access network selection scheme, in which RNC 183, node 104 and/or one or more other cellular network elements select an access network to be utilized by UE 102. For example, RNC 183 and/or node 104 may be configured to control access network selection for UE 102, e.g., as described below.

In one example, RNC 183 and/or node 104 may be configured to selectively trigger UE 102 to start or stop offloading to a WLAN, for example, the WLAN 107 controlled by AP 106, e.g., as described below.

In some demonstrative embodiments, RNC 183, UE 102, node 104 and/or AP 106 may be configured to enable a UE-centric (also referred to as “UE controlled”) access network selection scheme, in which UE 102 may select an access network to be utilized by UE 102. For example, UE 102 may select the access network based on network assistance information, which may be received from RNC 183, e.g., via node 104, and/or based on any other information and/or criteria from any other element of system 100, e.g., as described below.

In some demonstrative embodiments, cooperation between cellular networks, e.g., between RNC 183 and/or node 104, and WLAN networks, e.g., AP 106, may enable making network assignment decisions which maximize overall system performance, e.g., in terms of load, throughput, and the like. Additionally or alternatively, the cellular networks and WLAN networks may cooperate to provide optimal network assistance information, which may enable steering users towards decisions that improve system-wide performance.

In some demonstrative embodiments, RNC 183 may be configured to control, e.g., via node 104, network selection and/or traffic steering of UE 102 between WLAN networks, e.g., WLAN 107, and cellular networks, e.g., cell 103, e.g., as described below.

In one example, RNC 183 may be configured to control, e.g., via node 104, network selection and/or traffic steering of UE 102 between the WLAN networks and the cellular networks through direct network initiated triggers, e.g., as described below.

In another example, RNC 183 may be configured to control, e.g., via node 104, network selection and/or traffic steering of UE 102 between the WLAN networks and the cellular networks by using network assistance to assist, steer and/or control UE network selection, e.g., as described below.

Some demonstrative embodiments may be implemented, for example, without requiring any changes for WLAN interfaces, e.g., even if UE 102 is unable to provide cellular network statistics, e.g., of cell 103, to WLAN APs, e.g., to AP 106.

In some demonstrative embodiments, UE 102 may transmit to node 104 WLAN measurement information corresponding to WLAN 107, e.g., as described below.

In some demonstrative embodiments, node 104 may report the WLAN measurement information to RNC 183, e.g., as described below.

In some demonstrative embodiments, RNC 183 may control node 104 to configure the WLAN measurements performed by UE 102, for example, using one or more configuration messages, which may be transmitted from node 104 to UE 102 via the cellular link between UE 102 and node 104, e.g., as described below.

For example, RNC 183 may control node 104 to transmit to UE 102 at least one configuration message to configure one or more WLAN measurements to be performed by UE 102 with respect to WLAN 107, e.g., as described below.

In some demonstrative embodiments, RNC 183 may control node 104 to request from UE 102 the WLAN information relating to one or more serving WLANs and/or neighboring WLANs, e.g., including WLAN 107, for example, a Neighboring WLAN identifiers report, a Neighboring WLAN signal strength/rate report, a Neighboring WLAN signal strength/rate report, e.g., based on a BSS_Load_Info, “Serving” WLAN Load information, e.g., based on a BSS_Load_Info broadcast by AP 106, a “Serving” WLAN network overload indication, a UE current WLAN QoS indicator, e.g., per Quality of Service (QoS) Class Indicator (QCI) identifiers, a UE WLAN preference indicator, other “Detected WLAN” cells for which explicit measurements were not solicited, and/or any other information, e.g., as described below.

In some demonstrative embodiments, UE 102 may transmit to node 104 a report message including the WLAN measurement information measured by UE 102, e.g., including the WLAN measurement information corresponding to WLAN 107 and/or one or more other WLANs, e.g., as described below.

In some demonstrative embodiments, node 104 may provide the WLAN measurement information back to RNC 183, e.g., as described below.

In some demonstrative embodiments, UE may transmit the report message to node 104, when UE 102 is at a UE Connected mode (“the connected state”), for example, a Dedicated Chanel (CELL_DCH) state, Forward access channel (CELL_FACH) state, a (Cell Paging channel (CELL_PCH) state, or a Universal Terrestrial Radio Access Network (UTRAN) Registration Area (URA) paging channel (URA_PCH) state, e.g., as described below.

In some demonstrative embodiments, it may be easier for UE 102 to report the measurement information to RNC 183, e.g., via node 104, and/or for RNC 183 to control UE 102, e.g., via node 104, for example, when UE 102 is at the connected state, e.g., the CELL_DCH, CELL_FACH, CELL_PCH or URA_PCH state.

In some demonstrative embodiments, RNC 183 may collect the WLAN measurement information from UE 102, for example, when UE 102 is at the connected state, e.g., as described above.

In other embodiments, RNC 183 may collect the WLAN measurement information from UE 102, for example, when UE 102 is at an UE idle mode (“the Idle state”).

In some demonstrative embodiments, RNC 183 may schedule WLAN measurements to be performed by UEs connected to one or more nodes controlled by RNC 183. For example, RNC 183 may schedule WLAN measurements to be performed by UE 102 connected to node 104, e.g., as described below.

In some demonstrative embodiments, RNC 183 may control node 104 to transmit to a UE controlled by node 104, e.g., UE 102, scheduling information defining WLAN measurements to be performed by the UE with respect to a WLAN, e.g., WLAN 107.

In some demonstrative embodiments, controller 184 may control Iub 185 to send to node 104 the scheduling information defining the WLAN measurements to be performed by a UE, e.g., UE, 102, connected to node 104, with respect to at least one WLAN, e.g., WLAN 107.

In some demonstrative embodiments, Iub 146 may receive the scheduling information from RNC 183, and controller 144 may control wireless communication unit 130 to transmit to UE 102 a measurement control message to schedule the WLAN measurements based on the scheduling information, e.g., as described below.

In some demonstrative embodiments, wireless communication unit 110 may receive the measurement control message from node 104, and controller 145 may control wireless communication unit 110 to perform the WLAN measurements based on the measurement control message, e.g., as described below.

In some demonstrative embodiments, controller 145 may control wireless communication unit 110 to transmit to node 104 a measurement report based on the WLAN measurements performed by UE 102, e.g., as described below.

In some demonstrative embodiments, wireless communication unit 130 may receive the measurement report from UE 102, and controller 144 may control Iub 146 to send to RNC 183 a measurement update report including WLAN information of WLAN 107 based on the measurement report received from UE 102.

In some demonstrative embodiments, Iub 185 may receive the measurement update report from node 104.

In some demonstrative embodiments, RNC 183 may control access network selection of a UE, e.g., UE 102, for example, via a node connected to the UE, e.g., node 104, as described below.

In some demonstrative embodiments, RNC 183 may control the access network selection for UE 102, for example, based on one or more measurement update reports received from one or more nodes.

In some demonstrative embodiments, RNC 183 may control the access network selection for UE 102, for example, based on the measurement update report received from node 104 and/or one or more other nodes. The measurement update report may include information measured by UE 102 and/or one or more other UEs, with respect to one ore more WLANs, e.g., WLAN 107, which may be in a range of UE 102.

In some demonstrative embodiments, RNC 183 may control node 104 to trigger UE 102 to initiate or terminate offloading to WLAN 107, e.g., as described below.

In some demonstrative embodiments, controller 184 may determine whether UE 102 is to initiate or terminate offloading to WLAN 107, for example, based on a network load of cell 103, a network load of WLAN 107, radio conditions of cell 103 and/or WLAN 107, and/or any other parameter and/or offload-selection criterion relating to WLAN 107, cell 103 and/or one or more other cells and/or WLANs.

In some demonstrative embodiments, controller 184 may determine whether UE 102 is to initiate or terminate offloading to WLAN 107 based on an offload-selection criterion, which may be configured to maximize UE throughput, load balance traffic between UMTS and WLAN and/or based on any other parameter.

In some demonstrative embodiments, controller 184 may control Iub 185 to send to node 104 a trigger indication to indicate a UE connected to node 104, e.g., UE 102, is to be triggered to initiate or terminate offloading to a WLAN, e.g., WLAN 107.

In some demonstrative embodiments, Iub 146 may receive the trigger indication, and controller 144 may control wireless communication unit 130 to transmit to UE 102 a trigger message based on the trigger indication.

In some demonstrative embodiments, wireless communication unit 110 may receive the trigger message from node 104.

In some demonstrative embodiments, controller 145 may control access network selection of UE 102, for example, based on the trigger message from node 104.

In some demonstrative embodiments, RNC 183 may explicitly initiate the offloading of UE 102 to WLAN 107, for example, when UE is at the connected state, e.g., the CELL-DCH state or any other connected state, with respect to the UMTS, e.g., via node 104.

In some demonstrative embodiments, UE 102 may stay connected to the UMTS, e.g., via node 104, when UE 102 is offloading to WLAN 107, for example, to enable RNC 183 to terminate the offloading of UE 102 to WLAN 107.

For example, UE 102 may receive a first trigger message from node 104 to trigger UE to offload to WLAN 107, and, in response to the first trigger message, UE 102 may connect to WLAN 107, e.g., while remaining connected to node 104. UE 102 may later receive a second trigger message from node 104, e.g., via the connection with node 104, to trigger UE to terminate the offloading to WLAN 107, and, in response to the second trigger message, UE 102 may terminate the connection to WLAN 107, e.g., while remaining connected to node 104.

In some demonstrative embodiments, the measurement information received from UE 102 may be used by the cellular network, e.g., by RNC 183 and/or any other element of the cellular network, with respect to assisting and/or controlling WLAN mobility decisions, full network controlled mobility and/or UE controlled mobility with network assistance, as described below.

In some demonstrative embodiments, WLAN measurement information collected by RNC 183 may be utilized as part of UE-centric access network selection schemes, in which UE 102 may select an access network to be utilized by UE 102, e.g., as described below.

In some demonstrative embodiments, RNC 183 may determine UE-assistance information based on the WLAN measurements received by RNC 183.

In some demonstrative embodiments, RNC 183 may be able to determine network assistance information corresponding to WLAN 107, for example, based on the measurement information received from UE 102 and/or from one or more other UEs, e.g., as described below.

For example, controller 184 may determine network assistance information corresponding to WLAN 107 and/or one or more other WLANs, e.g., based on the measurement information received from UE 102.

According to this example, RNC 183 may control node 104 to transmit one or more messages including the network assistance information, e.g., a broadcast message to be received by one or more UEs and/or a dedicated message addressed to a particular UE.

In some demonstrative embodiments, RNC 183 may collect WLAN measurements relating to one or more WLANs, e.g., including WLAN 107 and/or one or more other WLANs, from one or more nodes, e.g., node 104 and/or one or more other nodes.

In one example, RNC 183 may receive WLAN measurements corresponding to WLAN 107 from one or more UEs other than UE 102 and/or from one or more nodes other than node 104.

According to this example, RNC 183 may determine UE-assistance information corresponding to WLAN 107, based on the WLAN measurements. RNC 183 may provide the UE-assistance information to UE 102, e.g., via node 104.

In some demonstrative embodiments, controller 184 may control Iub 185 to send the UE-assistance information to node 104.

In some demonstrative embodiments, Iub 146 may receive the UE-assistance information from RNC 183.

In some demonstrative embodiments, controller 144 may control wireless communication unit 130 to transmit a message including the UE-assistance information.

In one example, node 104 may broadcast one or more messages, e.g., RRC messages, for example, to be received by one or more UEs within a coverage area of cell 103, e.g., UEs in the UE idle mode and/or UEs in the CELL_DCH, CELL_FACH, CELL_PCH and/or URA_PCH states.

In another example, node 104 may transmit a message including the UE-assistance information directly to a UE within a coverage area of cell 103 at the connected state, e.g., a UE in the CELL_DCH, CELL_FACH, CELL_PCH or URA_PCH states.

In some demonstrative embodiments, controller 144 may control wireless communication unit 130 to transmit the UE-assistance information to UE 102, e.g., as a dedicated message addressed to UE 102.

In some demonstrative embodiments, controller 144 may control wireless communication unit 130 to broadcast the UE-assistance information to be received by one or more UEs camped on cell 103.

In some demonstrative embodiments, the UE-assistance information may include or may represent a cellular load, a WLAN load, cellular signal strength thresholds used for mobility decisions, e.g. a Received Signal Code Power (RSCP) threshold, WLAN signal strength thresholds used for mobility decisions, e.g., a RSSI threshold, an offload preference indicator, a WLAN overload indicator, WLAN cell-barring information, a Probability for WLAN network selection, a Probability for WLAN network selection per QCI, and/or any other assistance information to assist access network selection by UE 102.

In some demonstrative embodiments, wireless communication unit 110 may receive the UE-assistance information from node 104.

In some demonstrative embodiments, controller 145 may select an access network to be used by UE 102 based, for example, on the UE-assistance information and/or based on any other information and/or criteria from any other element of system 100.

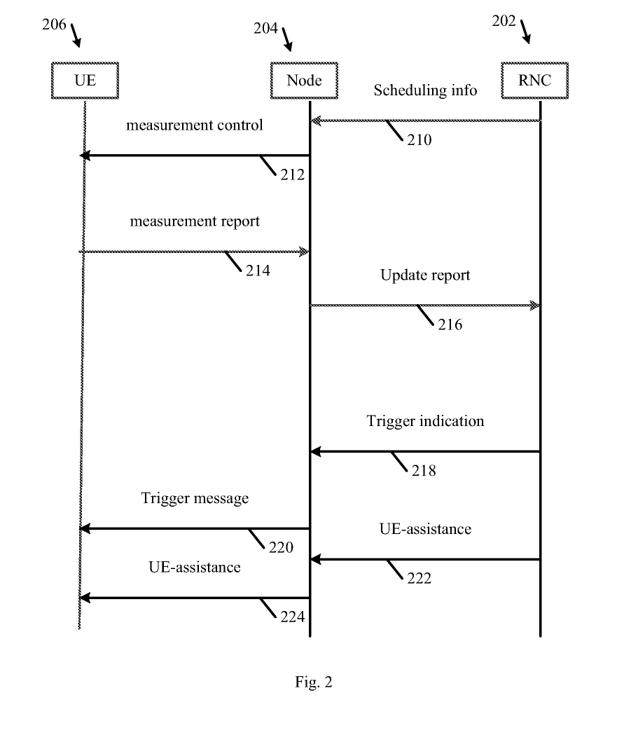

Reference is now made to FIG. 2, which schematically illustrates a sequence diagram of communicating WLAN measurement information and network selection of a UE, in accordance with some demonstrative embodiments.

In some demonstrative embodiments, an RNC 202 may send scheduling information 210 to a node 204 to schedule for one or more UEs connected to node 204, e.g., a UE 206, WLAN measurements corresponding to one or more WLANs. For example, RNC 202 may perform the functionality of RNC 183 (FIG. 1), node 204 may perform the functionality of node 104 (FIG. 1) and/or UE 206 may perform the functionality of UE 102 (FIG. 1).

In some demonstrative embodiments, RNC 202 may send scheduling information 210 as part of a System Information Update Request. For example, controller 184 (FIG. 1) may control Iub 185 (FIG. 1) to send to node 104 (FIG. 1) a System Information Update Request including scheduling information defining WLAN measurements to be performed by UE 102 (FIG. 1) with respect to WLAN 107 (FIG. 1).

In some demonstrative embodiments, scheduling information 210 may include one or more parameters corresponding to at least one WLAN, e.g., WLAN 107 (FIG. 1), for which measurements are requested.

In one example, scheduling information 210 may include at least one identifier of the WLAN, at least one frequency band of the WLAN, at least one frequency channel of the WLAN, and/or any other parameter, e.g., as described below.

In some demonstrative embodiments, RNC 202 may determine a WLAN for which measurements are to be performed, for example, if the WLAN is considered to be a suitable candidate for mobility of UE 206.

In some demonstrative embodiments, node 204 may transmit to UE 206 a measurement control message 212 to schedule the measurements to be performed by UE 206 based on scheduling information 210. For example, Iub 146 (FIG. 1) may receive scheduling information 210, and controller 144 (FIG. 1) may control wireless communication unit 130 (FIG. 1) to transmit measurement control message 212 to UE 102 (FIG. 1).

In some demonstrative embodiments, measurement control message 212 may include one or more parameters corresponding to at least one WLAN, e.g., WLAN 107, for which measurements are requested.

In some demonstrative embodiments, measurement control message 212 may include a Measurement Information Element (IE) including the at least one parameter, e.g., as described below.

In one example, measurement control message 212 may include at least one identifier of the WLAN, at least one frequency band of the WLAN, at least one frequency channel of the WLAN, and/or any other parameter, e.g., as described below.

In some demonstrative embodiments, the identifier of the WLAN may include, for example, a Service Set Identification (SSID), an Extended SSID (ESSID), a Basic SSID (BSSID), a Roaming Consortium, a Hotspot Operator Friendly Name, a Network Access Identifier (NAI) Home Realm, a Mobility Domain, and/or any additional or alternative identifier of the WLAN.

In some demonstrative embodiments, control message 212 the WLAN identifier (“WLAN id”) as part of an Inter Radio Access Technology (Inter-RAT) measurement IE. In one example, control message 212 may include one or more Inter-RAT measurement IEs, e.g., one or more of the following IEs:

| Information | | | | | |
|---|---|---|---|---|---|
| Element/ | | | Type and | Semantics | Ver- |
| Group name | Need | Multi | reference | description | sion |
| CHOICE | OP | | | | REL-8 |
| Inter-RAT | | | | | |
| measurement | | | | | |
| objects | | | | | |
| >Inter-RAT | MP | | Inter-RAT | | |
| cell info | | | cell info list | | |
| list | | | 10.3.7.23 | | |
| >E-UTRA | MP | | E-UTRA | | REL-8 |
| frequency | | | frequency | | |
| list | | | list | | |
| | | | 10.3.7.6b | | |
| Inter-RAT | OP | | Inter-RAT | | |
| measurement | | | measurement | | |
| quantity | | | quantity | | |
| | | | 10.3.7.29 | | |
| Inter-RAT | OP | | Inter-RAT | | |
| reporting | | | reporting | | |
| quantity | | | quantity | | |
| | | | 10.3.7.32 | | |
| Reporting | CV- | | Reporting | | |
| cell status | reporting | | cell status | | |
| | | | 10.3.7.61 | | |
| CHOICE | MP | | | | |
| report | | | | | |
| criteria | | | | | |
| >Inter-RAT | | | Inter-RAT | | |
| measurement | | | measurement | | |
| reporting | | | reporting | | |
| criteria | | | criteria | | |
| | | | 10.3.7.30 | | |
| >Periodical | | | Periodical | | |
| reporting | | | reporting | | |
| criteria | | | criteria | | |
| | | | 10.3.7.53 | | |
| >No | | | | (no data) | |
| reporting | | | | Chosen | |
| | | | | when this | |
| | | | | measurement | |
| | | | | only is used | |
| | | | | as additional | |
| | | | | measurement | |
| | | | | to another | |
| | | | | measurement | |
| Idle Interval | OP | | Idle Interval | This IE is used | REL-8 |
| Information | | | Information | for TDD only. | |
| | | | 10.3.7.12a | | |

| Condition | Explanation |
|---|---|
| Reporting | This IE is optional if the CHOICE |
| | “report criteria” is equal to |
| | “periodical reporting criteria” |
| | or “No reporting”, otherwise |
| | the IE is not needed |

In one example, the Inter-Rat cell info list IE may include information for a list of measurement objects for an inter-RAT measurement. The Inter-Rat cell info list IE may include, for example, the WLAN id, e.g., as follows:

| Information | | | Type | | |
|---|---|---|---|---|---|
| Element/ | | | and | Semantics | |
| Group name | Need | Multi | reference | description | Version |
| CHOICE Inter-RAT | MP | | | | |
| cell removal | | | | | |
| >Remove all inter-RAT | | | | (no data) | |
| cells | | | | | |
| >Remove some inter-RAT | | | | | |
| cells | | | | | |
| >>Removed inter-RAT | MP | 1 to <max | | | |
| cells | | CellMeas> | | | |
| >>>Inter-RAT cell id | MP | | Integer | | |
| | | | (0 . . . <max | | |
| | | | CellMeas> −1) | | |
| >Remove no inter-RAT | | | | (no data) | |
| cells | | | | | |
| New inter-RAT cells | MP | 1 to <max | | Although this IE | |
| | | CellMeas> | | is not always | |
| | | | | required, need | |
| | | | | is MP to align | |
| | | | | with ASN.1 | |
| | OP | | | | REL-4 |
| >Inter-RAT cell id | OP | | Integer | | |
| | | | (0 . . . <max | | |
| | | | CellMeas> −1) | | |
| >CHOICE Radio Access | MP | | | | |
| Technology | | | | | |
| >>GSM | | | | | |
| >>>Cell individual | MP | | Integer | In dB | |
| offset | | | (−50 . . . 50) | Used to offset | |
| | | | | measured | |
| | | | | quantity value | |
| >>>Cell selection | OP | | Cell | See | |
| and re-selection info | | | selection | subclause | |
| | | | and re- | 8.6.7.3 | |
| | | | selection info | | |
| | | | for SIB11/12 | | |
| | | | 10.3.2.4 | | |
| >>>BSIC | MP | | BSIC | | |
| | | | 10.3.8.2 | | |
| >>>Band indicator | MP | | Enumerated | Indicates how | |
| | | | (DCS 1800 | to interpret | |
| | | | band used, | the BCCH | |
| | | | PCS 1900 | ARFCN | |
| | | | band used) | | |
| >>>BCCH | MP | | Integer | [45] | |
| ARFCN | | | (0 . . . 1023) | | |
| >>IS-2000 | | | | | |
| >>>System specific | MP | | enumerated | For IS-2000, | |
| measurement info | | | (frequency, | use fields from | |
| | | | timeslot, | TIA/EIA/ | |
| | | | colour code, | IS-2000.5, | |
| | | | output | subclause 3. | |
| | | | power, PN | 7.3.3.2.27, | |
| | | | offset) | Candidate | |
| | | | | Frequency | |
| | | | | Neighbour List | |
| | | | | Message | |
| >>None | | | (no data) | This value | |
| | | | | has been | |
| | | | | introduced to | |
| | | | | handle the | |
| | | | | case when IE | |
| | | | | “New inter- | |
| | | | | RAT cells” is | |
| | | | | not required | |
| WLAN id | OP | | | | |
| Cell for | OP | 1 to <max | | | |
| measurement | | CellMeas> | | | |
| >Inter-RAT cell id | MP | | Integer(0 . . . | | |
| | | | <max | | |
| | | | CellMeas> −1) | | |
| Inter-RAT cell info | CV-Message | | Integer | NOTE 1 and 2 | REL-5 |
| indication | | | (0 . . . 3) | | |

| Condition | Explanation |
|---|---|
| Message | The IE is optionally present |
| | in the MEASUREMENT CONTROL |
| | and in the SRNS RELOCATION |
| | INFO messages, otherwise |
| | the IE is not needed. |

In some demonstrative embodiments, node 204 may transmit measurement control message 212 as part of a System Information Block (SIB).

In one example, node 204 may transmit measurement control message 212 as part of a SIB Type 11.

In one example the SIB Type 11 may include measurement control message 212 as part of a WLAN measurement control system information IE of the SIB Type 11, e.g., as follows:

| Information | | | | |
|---|---|---|---|---|
| Element/ | | | | |
| Group | | | Type and | Semantics |
| name | Need | Multi | reference | description |
| SIB12 Indicator | MP | | Boolean | TRUE indicates |
| | | | | that SIB12 |
| | | | | is broadcast |
| | | | | in the cell. |
| Measurement | | | | |
| information | | | | |
| elements | | | | |
| FACH | OP | | FACH | If the cell is |
| measurement | | | measurement | operating in |
| occasion info | | | occasion | MBSFN mode |
| | | | info | as indicated |
| | | | 10.3.7.8 | in subclause |
| | | | | 8.1.1.6.3 the |
| | | | | UE behaviour |
| | | | | upon reception |
| | | | | of this IE is |
| | | | | unspecified. |
| Measurement | MP | | Measurement | For 1.28 Mcps |
| control system | | | control | TDD if the |
| information | | | system | cell is operating |
| | | | information | in MBSFN |
| | | | 10.3.7.47 | only mode the UE |
| | | | | behaviour upon |
| | | | | reception of this |
| | | | | IE is unspecified. |
| MBSFN | OP | | MBSFN | If present |
| frequency list | | | frequency | contains all |
| | | | list | neighbouring |
| | | | 10.3.9a.12a | frequencies of |
| | | | | MBSFN clusters |
| | | | | operating in |
| | | | | MBSFN mode |
| | | | | as indicated in |
| | | | | subclause |
| | | | | 8.1.1.6.3. |
| | | | | If the cell is |
| | | | | operating in |
| | | | | MBSFN mode as |
| | | | | indicated |
| | | | | in subclause |
| | | | | 8.1.1.6.3 the |
| | | | | UE behaviour |
| | | | | upon |
| | | | | reception of |
| | | | | this IE is |
| | | | | unspecified. |
| WLAN | OP | | | |
| measurement | | | | |
| control system | | | | |
| information | | | | |

In another example, node 204 may transmit measurement control message 212 as part of a SIB Type 12, e.g., as follows:

| Information | | | Type | |
|---|---|---|---|---|
| Element/ | | | and | Semantics |
| Group name | Need | Multi | reference | description |
| Measurement | | | | |
| information | | | | |
| elements | | | | |
| FACH | OP | | FACH | |
| measurement | | | measurement | |
| occasion info | | | occasion | |
| | | | info 10.3.7.8 | |
| Measurement | MP | | Measurement | |
| control system | | | control | |
| information | | | system | |
| | | | information | |
| | | | 10.3.7.47 | |
| WLAN | OP | | | |
| measurement control | | | | |
| system information | | | | |

In some demonstrative embodiments, node 204 may transmit measurement control message 212 as part of a RRC message.

In one example, node 204 may transmit measurement control message 212 as part of an RRC measurement control message, which may be configured to be sent from the UMTS network to a UE, e.g., over a Dedicated Control Channel (DCCH), for example, to setup, modify or release a measurement. For example, the RRC message may include the following information:

| Information | | | | | |
|---|---|---|---|---|---|
| Element/ | | | Type and | Semantics | Ver- |
| Group name | Need | Multi | reference | description | sion |
| Message Type | MP | | Message Type | | |
| UE information | | | | | |
| elements | | | | | |
| RRC transaction | MP | | RRC | | |
| identifier | | | transaction | | |
| | | | identifier | | |
| | | | 10.3.3.36 | | |
| Integrity check | CH | | Integrity check | | |
| info | | | info 10.3.3.16 | | |
| Measurement | | | | | |
| Information | | | | | |
| elements | | | | | |
| Measurement | MP | | Measurement | | |
| Identity | | | Identity | | |
| | | | 10.3.7.48 | | |
| Measurement | MP | | Measurement | | |
| Command | | | Command | | |
| | | | 10.3.7.46 | | |
| Measurement | OP | | Measurement | | |
| Reporting | | | Reporting | | |
| Mode | | | Mode | | |
| | | | 10.3.7.49 | | |
| Additional | OP | | Additional | | |
| measurements | | | measurements | | |
| list | | | list 10.3.7.1 | | |
| CHOICE | CV- | | | | |
| Measurement | command | | | | |
| type | | | | | |
| >Intra- | | | Intra- | | |
| frequency | | | frequency | | |
| measurement | | | measurement | | |
| | | | 10.3.7.36 | | |
| >Inter- | | | Inter- | | |
| frequency | | | frequency | | |
| measurement | | | measurement | | |
| | | | 10.3.7.16 | | |
| >Inter-RAT | | | Inter-RAT | | |
| measurement | | | measurement | | |
| | | | 10.3.7.27 | | |
| >UE | | | UE positioning | | |
| positioning | | | measurement | | |
| measurement | | | 10.3.7.100 | | |
| >Traffic | | | Traffic Volume | | |
| Volume | | | measurement | | |
| measurement | | | 10.3.7.68 | | |
| >Quality | | | Quality | | |
| measurement | | | measurement | | |
| | | | 10.3.7.56 | | |
| >UE internal | | | UE internal | | |
| measurement | | | measurement | | |
| | | | 10.3.7.77 | | |
| >CSG Proximity | | | CSG Proximity | | REL-9 |
| detection | | | detection | | |
| | | | 10.3.7.123 | | |
| >E-UTRA | | | E-UTRA | | REL- |
| measurement | | | measurement | | 11 |
| for | | | for | | |
| CELL_FACH | | | CELL_FACH | | |
| | | | 10.3.7.137 | | |
| CELL_DCH | OP | | CELL_DCH | | REL-9 |
| measurement | | | measurement | | |
| occasion | | | occasion info | | |
| info LCR | | | LCR | | |
| | | | 10.3.7.126 | | |
| Physical | | | | | |
| channel | | | | | |
| information | | | | | |
| elements | | | | | |
| DPCH | OP | | DPCH | | |
| compressed | | | compressed | | |
| mode status | | | mode status | | |
| info | | | info | | |
| | | | 10.3.6.34 | | |

| Condition | Explanation |
|---|---|
| Command | The IE is mandatory present if the IE |
| | “Measurement command” |
| | is set to “Setup”, optional if the IE |
| | “Measurement command” is set |
| | to “modify”, otherwise |
| | the IE is not needed. |

In some demonstrative embodiments, UE 206 may perform measurements of one or more WLANs, for example, based on the measurements defined by measurement control message 212. For example, UE 206 may perform measurements of a WLAN identified by the WLAN identifier of measurement control message 212.

In other embodiments, UE 206 may be configured to perform WLAN measurements with respect to any WLAN networks, which are in range of UE 206. According to these embodiments, UE 206 may be configured to perform the WLAN measurements, e.g., with respect to one or more WLANs not identified by measurement control message 212 and/or even if measurement control message 212 is not received by UE 206.

In some demonstrative embodiments, UE 206 may measure, e.g., using a WLAN baseband of radio 143 (FIG. 1), WLAN measurement information corresponding to the one or more WLANs, e.g., WLAN 107 (FIG. 1), identified by measurement control message 212.

In some demonstrative embodiments, UE 206 may transmit to node 204 at least one measurement report message 214 including the WLAN measurements, as measured by UE 206 with respect to the one or more requested WLANs. For example, controller 145 (FIG. 1) may control wireless communication unit 110 (FIG. 1) to transmit to node 104 (FIG. 1) at least one measurement report message 214 including the WLAN measurement information corresponding to WLAN 107 and/or one or more other WLANs.

In some demonstrative embodiments, UE 206 may transmit the measurement report message 214 based on measurement reporting configuration information defined by node 204, e.g., as part of measurement control message 212.

In some demonstrative embodiments, measurement report message 214 may include one or more types of WLAN measurement information, e.g., including one or more of the following parameters and/or any other information corresponding to the WLAN:
1. SSID or ESSID;
2. BSSID;
3. Other WLAN identifiers, e.g., one or more identifiers as defined in the HotSpot 2.0 specification, e.g. Roaming Consortium, Hotspot Operator Friendly Name, NAI Home Realm, Mobility Domain, and/or any other WLAN identifiers;
4. Channel/frequency;
5. Privacy and security;
6. Receive signal strength indicator (RSSI), e.g., as defined by IEEE 802.11-2012;
7. Received channel power indicator (RCPI), e.g., as defined by IEEE 802.11-2012;
8. Received power indicator (RPI), e.g., as defined by IEEE 802.11-2012;
9. Received signal to noise indicator (RSNI), e.g., as defined by IEEE 802.11-2012;
10. Channel traffic, e.g., as defined by IEEE 802.11-2012;
11. Channel load, e.g., as defined by IEEE 802.11-2012;
12. Noise histogram, e.g., as defined by IEEE 802.11-20121;
13. STA statistics, e.g., as defined by IEEE 802.11-2012;
14. Location, e.g., as defined by IEEE 802.11-2012;
15. Neighbor report, e.g., as defined by IEEE 802.11-2012;
16. Link measurement, e.g., as defined by IEEE 802.11-2012;
17. BSS Load, e.g., as defined by IEEE 802.11-2012;
18. AP Channel Report, e.g., as defined by IEEE 802.11-2012;
19. BSS Available Admission Capacity, e.g., as defined by IEEE 802.11-2012;
20. BSS AC Access Delay, e.g., as defined by IEEE 802.11-2012;
21. Supported rates, e.g., as defined by IEEE 802.11-2012;
22. Extended Supported Rates, e.g., as defined by IEEE 802.11-2012; and/or
23. Power Constraint, e.g., as defined by IEEE 802.11-2012.

In some demonstrative embodiments, measurement report message 214 may include a Measurement Information Element (IE) including the WLAN measurement information, e.g., as described below.

In one example, measurement report message 214 may include the following IE (“WLAN measured results IE”):

### WLAN Measured Results

| Information | | | | | |
|---|---|---|---|---|---|
| Element/ | | | Type and | Semantics | |
| Group name | Need | Multi | reference | description | Version |
| WLAN | MP | 1 to | | | |
| measured | | <maxReported | | | |
| results list | | WLANFreqs> | | | |
| >WLAN | | | | | |
| Frequency | | | | | |
| >WLAN | | | | | |
| BSS Load | | | | | |

In some demonstrative embodiments, UE 206 may transmit measurement report message 214 as part of a RRC message.

In one example, UE 206 may transmit measurement report message 214 as part of an RRC measurement report message, which may be configured to be sent from a UE to the UMTS network, e.g., over a DCCH, for example, to report measurement results from the UE.

For example, the RRC message may include the WLAN measured results IE, e.g., as follows:

| Information | | | | | |
|---|---|---|---|---|---|
| Element/ | | | Type and | Semantics | |
| Group name | Need | Multi | reference | description | Version |
| Message Type | MP | | Message Type | | |
| UE information | | | | | |
| elements | | | | | |
| Integrity check info | CH | | Integrity | | |
| | | | check info | | |
| | | | 10.3.3.16 | | |
| Activation time | CV- | | Activation | | REL-8 |
| | PreConf | | time | | |
| | | | 10.3.3.1 | | |
| Measurement | | | | | |
| Information | | | | | |
| Elements | | | | | |
| Measurement identity | MP | | Measurement | | |
| | | | identity | | |
| | | | 10.3.7.48 | | |
| Measured Results | OP | | Measured | | |
| | | | Results | | |
| | | | 10.3.7.44 | | |
| Measured Results | OP | | Measured | | REL-9 |
| on secondary | | | Results | | |
| UL frequency | | | on secondary | | |
| | | | UL frequency | | |
| | | | 10.3.7.118 | | |
| Measured Results on | OP | | Measured | | |
| RACH | | | Results | | |
| | | | on RACH | | |
| | | | 10.3.7.45 | | |
| Additional Measured | OP | 1 to | | | |
| results | | <maxAdditional | | | |
| | | Meas> | | | |
| >Measured Results | MP | | Measured | | |
| | | | Results | | |
| | | | 10.3.7.44 | | |
| Additional Measured | OP | 1 to | | | REL-9 |
| results on secondary | | <maxAdditional | | | |
| UL frequency | | Meas> | | | |
| >Measured Results | MP | | Measured | | |
| | | | Results | | |
| | | | on | | |
| | | | secondary | | |
| | | | UL frequency | | |
| | | | 10.3.7.118 | | |
| Event results | OP | | Event | | |
| | | | results | | |
| | | | 10.3.7.7 | | |
| Event results on | OP | | Cell measurement | | REL-9 |
| secondary UL frequency | | | event results on | | |
| | | | secondary UL | | |
| | | | frequency | | |
| | | | 10.3.7.117 | | |
| Inter-RAT cell info | CV- | | Integer | | REL-5 |
| indication | IRAT | | (0 . . . 3) | | |
| E-UTRA Measured | OP | | E-UTRA | | REL-8 |
| Results | | | Measured | | |
| | | | Results | | |
| | | | 10.3.7.6c | | |
| E-UTRA Event Results | OP | | E-UTRA | | REL-8 |
| | | | Event | | |
| | | | Results | | |
| | | | 10.3.7.6a | | |
| E-UTRA results for | OP | | E-UTRA | | REL-11 |
| CELL_FACH | | | results for | | |
| | | | CELL_FACH | | |
| | | | 10.3.7.138 | | |
| CSG Proximity | OP | | 10.3.7.122 | | REL-9 |
| Indication | | | | | |
| Other Information | | | | | Rel-10 |
| elements | | | | | |
| Logged Meas | OP | | Enumerated | Indicates the UE | Rel-10 |
| Available | | | (TRUE) | has logged | |
| | | | | measurements to | |
| | | | | report to the | |
| | | | | network | |
| ANR Logging Results | OP | | Enumerated | True indicates the | REL-10 |
| Available | | | (TRUE) | UE has ANR | |
| | | | | logging results to | |
| | | | | report to the | |
| | | | | Network. | |
| WLAN Measured | OP | | | | |
| Results | | | | | |

| Condition | Explanation |
|---|---|
| IRAT | The IE is optionally present if at least one of the IE |
| | “Inter-RAT measured results list” and the IE “Inter-RAT |
| | measurement event results” is included in the message. |
| | Otherwise, the IE is not needed. |
| PreConf | The IE is mandatory if the table “Target cell |
| | preconfigurations” in the variable includes the |
| | cell that triggered the event and the IE |
| | “Activation time offset” is different from 0. |
| | Otherwise, the IE is not needed. |

In some demonstrative embodiments, node 204 may send to RNC an update report 216 including the WLAN measurements reported by one or more report messages 214 received by node 204 from one or more UEs.

In some demonstrative embodiments, node 204 may send update report 216 as part of a System Information Update Response. For example, controller 144 (FIG. 1) may control Iub 146 (FIG. 1) to send to RNC 183 (FIG. 1) a System Information Update Response including WLAN measurement information received from UE 102 (FIG. 1) with respect to WLAN 107 (FIG. 1).

In some demonstrative embodiments, RNC 202 may control access network selection of UE 206, for example, based on the WLAN measurement information of one or more reports 216 from one of more nodes 204, e.g., as described below.

In some demonstrative embodiments, RNC 202 may select whether to trigger initiation or termination of WLAN offload of UE 206 to or from a WLAN network, for example, based on the measurement information received from UE 206, measurement information received from one or more other UEs and/or nodes, and/or based on any other information, e.g., as described above.

In some demonstrative embodiments, RNC 202 may send a trigger indication 218 to node 204. For example, controller 184 (FIG. 1) may control Iub 185 (FIG. 1) to send trigger indication 218 to node 104 (FIG. 1).

In some demonstrative embodiments, trigger indication 218 may indicate that UE 206 is to initiate or terminate offloading to the WLAN network.

In some demonstrative embodiments, node 204 may transmit to UE 206 a trigger message 220 based on trigger indication 218.

In some demonstrative embodiments, trigger indication 218 and/or trigger message 220 may be communicated as part of an RRC message.

In some demonstrative embodiments, trigger indication 218 and/or trigger message 220 may be communicated as part of a dedicated RRC message, which may be configured, for example, to handover and/or direct UE 206 to or from the WLAN network.

In some demonstrative embodiments, trigger indication 218 and/or trigger message 220 may be communicated as part of a HANDOVER FROM UTRAN COMMAND, which may be configured to handover UE 206 to the WLAN network.

In one example, the HANDOVER FROM UTRAN COMMAND may include a WLAN handover IE to indicate the WLAN to which handover is to be performed. For example, the HANDOVER FROM UTRAN COMMAND may include the WLAN SSID of the WLAN network, e.g., as follows:

| Information | | | | | |
|---|---|---|---|---|---|
| Element/ | | | Type and | Semantics | |
| Group name | Need | Multi | reference | description | Version |
| Message Type | MP | | Message Type | | |
| UE information | | | | | |
| elements | | | | | |
| RRC transaction | MP | | RRC | | |
| identifier | | | transaction | | |
| | | | identifier | | |
| | | | 10.3.3.36 | | |
| Integrity | CH | | Integrity check | | |
| check info | | | info 10.3.3.16 | | |
| SR-VCC Info | CV-SRVCC | | SR-VCC info | | REL-8 |
| | | | 10.3.4.24a | | |
| rSR-VCC info | CV-rSRVCC | | rSR-VCC Info | | REL-11 |
| | | | 10.3.3.36a | | |
| Activation time | MD | | Activation time | Default value | |
| | | | 10.3.3.1 | is “now” | |
| RB information | | | | | |
| elements | | | | | |
| RAB information list | OP | 1 to | | For each RAB to | |
| | | <maxRABsetup> | | be handed over. In | |
| | | | | handover to | |
| | | | | GERAN lu mode | |
| | | | | the RAB | |
| | | | | information is | |
| | | | | included in the | |
| | | | | GERAN lu | |
| | | | | message below. | |
| >RAB info | MP | | RAB info | | |
| | | | 10.3.4.8 | | |
| RAB info to replace | CV-SRVCC | | RAB info to | | REL-8 |
| | | | replace | | |
| | | | 10.3.4.11a | | |
| Other information | | | | | |
| elements | | | | | |
| CHOICE System type | MP | | | This IE indicates | |
| | | | | which specification | |
| | | | | to apply, to decode | |
| | | | | the transported | |
| | | | | messages | |
| >GSM | | | | | |
| >>Frequency band | MP | | Enumerated | | |
| | | | (GSM/DCS | | |
| | | | 1800 band | | |
| | | | used), | | |
| | | | GSM/PCS | | |
| | | | 1900 band | | |
| | | | used) | | |
| >>CHOICE GSM | | | | | |
| message | | | | | |
| >>>Single GSM | MP | | Bit string (no | Formatted and | |
| message | | | explicit size | coded according to | |
| | | | constraint) | GSM specifications | |
| | | | | The first/leftmost/most | |
| | | | | significant bit of the | |
| | | | | bit string contains | |
| | | | | bit 8 of the first | |
| | | | | octet of the GSM | |
| | | | | message. | |
| >>>GSM message List | MP | 1.to.<maxInterSys | Bit string | Formatted and | |
| | | Messages> | (1 . . . 512) | coded according to | |
| | | | | GSM | |
| | | | | specifications. The | |
| | | | | first/leftmost/most | |
| | | | | significant bit of the | |
| | | | | bit string contains | |
| | | | | bit 8 of the first | |
| | | | | octet of the GSM | |
| | | | | message. | |
| >>CHOICE GERAN | OP | | | | REL-6 |
| System Info type | | | | | |
| >>>SI | MP | | GERAN | See [44] | REL-6 |
| | | | system | | |
| | | | information | | |
| | | | 10.3.8.4f | | |
| >>>PSI | MP | | GERAN | See [44] | REL-6 |
| | | | system | | |
| | | | information | | |
| | | | 10.3.8.4f | | |
| >GERAN lu | | | | | REL-5 |
| >>Frequency band | MP | | Enumerated | | REL-5 |
| | | | (GSM/DCS | | |
| | | | 1800 band | | |
| | | | used), | | |
| | | | GSM/PCS | | |
| | | | 1900 band | | |
| | | | used) | | |
| >>CHOICE GERAN lu | | | | | REL-5 |
| message | | | | | |
| >>>Single GERAN lu | MP | | Bit string (no | Formatted and | REL-5 |
| message | | | explicit size | coded according to | |
| | | | constraint) | [53]. The | |
| | | | | first/leftmost/most | |
| | | | | significant bit of the | |
| | | | | bit string contains | |
| | | | | bit 8 of the first | |
| | | | | octet of the | |
| | | | | message. | |
| >>>GERAN lu | MP | 1 to | Bit string | Formatted and | REL-5 |
| message | | <maxInterSys | (1 . . . 32768) | coded according to | |
| List | | Messages> | | [53]. The | |
| | | | | first/leftmost/most | |
| | | | | significant bit of the | |
| | | | | bit string contains | |
| | | | | bit 8 of the first | |
| | | | | octet of the | |
| | | | | message. | |
| >cdma2000 | | | | | |
| >>cdma2000Message | MP | 1.to.<maxInter | | | |
| List | | SysMessages> | | | |
| >>>MSG_TYPE(s) | MP | | Bit string (8) | Formatted and | |
| | | | | coded according to | |
| | | | | cdma2000 | |
| | | | | specifications. The | |
| | | | | MSG_TYPE bits | |
| | | | | are numbered b0 to | |
| | | | | b7. The | |
| | | | | first/leftmost/most | |
| | | | | significant bit of the | |
| | | | | bit string contains | |
| | | | | bit 7 of the | |
| | | | | MSG_TYPE. | |
| >>>cdma2000 | MP | | Bit string | Formatted and | |
| Message | | | (1 . . . 512) | coded according to | |
| payload(s) | | | | cdma2000 | |
| | | | | specifications. The | |
| | | | | first/leftmost/most | |
| | | | | significant bit of the | |
| | | | | bit string contains | |
| | | | | the bit 7 of the first | |
| | | | | octet of the | |
| | | | | cdma2000 | |
| | | | | message. | |
| >E-UTRA | | | | | REL-8 |
| >>E-UTRA | MP | | Octet string | Formatted and | REL-8 |
| message | | | | coded according to | |
| | | | | E-UTRA | |
| | | | | specifications The | |
| | | | | first/leftmost/most | |
| | | | | significant bit | |
| | | | | of the octet string | |
| | | | | contains bit 8 of the | |
| | | | | first octet of the E- | |
| | | | | UTRA message. | |
| >WLAN | | | | | |
| >> WLAN SSID | | | | | |

| Condition | Explanation |
|---|---|
| SRVCC | This IE is mandatory present when an SR-VCC |
| | procedure is initiated and not needed otherwise. |
| rSRVCC | This IE is mandatory present when an rSR-VCC |
| | procedure is initiated and not needed otherwise. |

In some demonstrative embodiments, trigger indication 218 and/or trigger message 220 may be communicated as part of a RRC CONNECTION RELEASE IE to redirect UE 206 to the WLAN network.

In one example, RRC CONNECTION RELEASE IE may include an IE to redirect a UE to another frequency or another system. For example, the RRC CONNECTION RELEASE IE may an IE (“WLAN target info”) including information of the WLAN network to which the UE is to redirect, e.g., as follows:

| Information | | | | | |
|---|---|---|---|---|---|
| Element/ | | | Type and | Semantics | |
| Group name | Need | Multi | reference | description | Version |
| CHOICE | MP | | | | |
| Redirection | | | | | |
| Information | | | | | |
| >Frequency info | | | Frequency | | |
| | | | info | | |
| | | | 10.3.6.36 | | |
| >Inter-RAT info | | | Inter-RAT | | |
| | | | info | | |
| | | | 10.3.7.25 | | |

### Inter-RAT Info

Inter-RAT info defines the target system for redirected cell selection.

| Information | | | | | |
|---|---|---|---|---|---|
| Element/ | | | Type and | Semantics | |
| Group name | Need | Multi | reference | description | Version |
| Inter-RAT | MP | | Enumerated | | REL-8 |
| info | | | (GSM, | | |
| | | | E-UTRA) | | |
| GSM target | CV-GSM | | GSM target | | REL-6 |
| cell info | | | cell info | | |
| | | | 10.3.8.4g | | |
| E-UTRA | CV-E- | | E-UTRA | | REL-8 |
| target info | UTRA | | target | | |
| | | | info | | |
| | | | 10.3.8.4L | | |
| WLAN | | | | | |
| target info | | | | | |

| Condition | Explanation |
|---|---|
| GSM | This IE is |
| | optionally present |
| | if the IE “Inter-RAT |
| | info” is set to |
| | ‘GSM’ and not needed |
| | otherwise. |
| E-UTRA | This IE is mandatory |
| | present if the IE |
| | “Inter-RAT info” is set to |
| | ‘E-UTRA’ and not |
| | needed otherwise. |

In some demonstrative embodiments, trigger indication 218 and/or trigger message 220 may be communicated as part of a RRC CONNECTION REJECT IE to redirect UE 206 to the WLAN network.

In one example, the RRC CONNECTION REJECT IE may include the WLAN target info, e.g., as part of the Inter-Rat info IE described above.

In some demonstrative embodiments, trigger indication 218 and/or trigger message 220 may be communicated as part of a HANDOVER TO UTRAN COMMAND to handover UE 206 from the WLAN network back to the UMTS controlled by RNC 202.

In some demonstrative embodiments, trigger message 220 may be configured to trigger UE 206 to initiate WLAN offload to any WLAN network, which may be selected by UE 206. According to these embodiments, UE 206 may select which WLAN network to connect to, e.g., based on a WLAN load, a WLAN Received Signal Strength Indicator (RSSI), or any other UE-centric network selection parameter or criterion.

In some demonstrative embodiments, trigger message 220 may include at least one WLAN identifier to identify at least one WLAN to which UE 206 is to connect. For example, the WLAN identifier may include, for example, a SSID or SSID list, an ESSID or ESSID list, a BSSID or BSSID list, a Roaming Consortium, a Hotspot Operator Friendly Name, a NAI Home Realm, a Mobility Domain, and/or any additional or alternative identifier of the WLAN.

In some demonstrative embodiments, RNC 202 may determine UE-assistance information, for example, based on the WLAN measurement information of one or more reports 216 from one of more nodes 204, e.g., as described below.

In some demonstrative embodiments, RNC 202 may send UE-assistance information 222 to node 204. For example, controller 184 (FIG. 1) may control Iub 185 (FIG. 1) to send UE-assistance information 222 to node 104 (FIG. 1).

In some demonstrative embodiments, UE-assistance information 222 may include WLAN information corresponding to one or more WLAN networks, e.g., WLAN 107 (FIG. 1), which may be considered for offloading by UE 206, e.g., as described above.

In some demonstrative embodiments, node 204 may transmit a UE-assistance message 220 including UE-assistance information 222.

In some demonstrative embodiments, UE-assistance message 220 may be communicated as part of an RRC message or any other message.

In some demonstrative embodiments, node 204 may transmit UE-assistance message 220 as a dedicated message addressed to node 206.

In some demonstrative embodiments, node 204 may broadcast UE-assistance message 220 to be received by one or more nodes camped on a cell controlled by node 204.

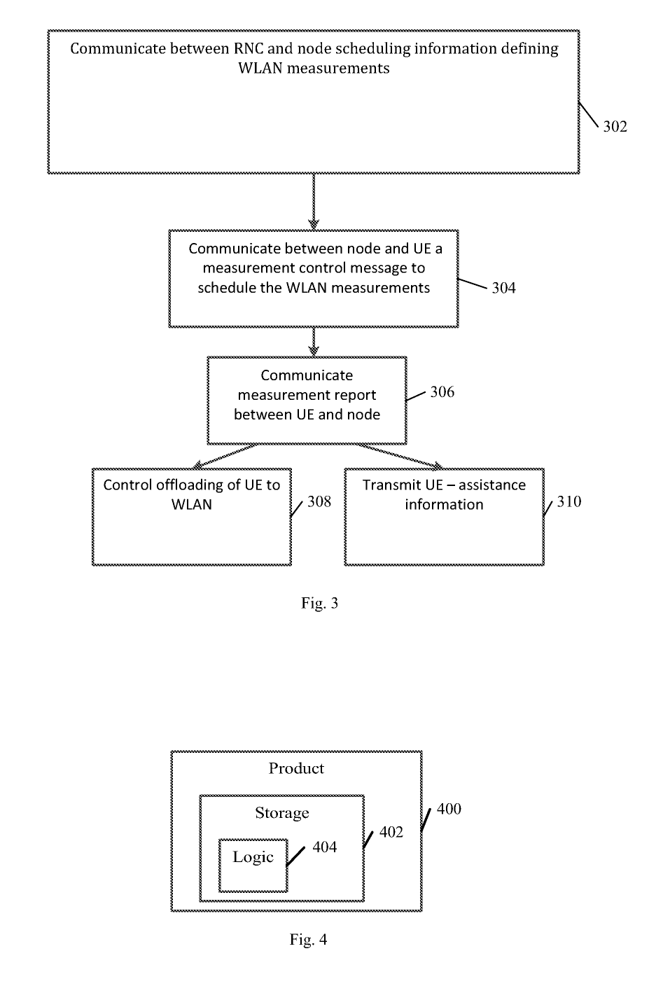

Reference is made to FIG. 3, which schematically illustrates a method of cellular network communication corresponding to a non-cellular network, in accordance with some demonstrative embodiments. In some embodiments, one or more of the operations of the method of FIG. 5 may be performed by a wireless communication system e.g., system 100 (FIG. 1); a wireless communication device, e.g., RNC 183 (FIG. 1), UE 102 (FIG. 1), node 104 (FIG. 1), and/or AP 106 (FIG. 1); an interface unit, e.g., Iub 185 (FIG. 1) and/or Iub 146 (FIG. 1); a controller, e.g., controller 184 (FIG. 1) and/or controller 144 (FIG. 1); and/or a wireless communication unit, e.g., wireless communication units 110 and/or 130 (FIG. 1).

As indicated at block 302, the method may include communicating between an RNC and a cellular node scheduling information defining WLAN measurements to be performed by at least one UE connected to the cellular node with respect to a WLAN. For example, RNC 183 (FIG. 1) may send scheduling information 210 (FIG. 2) to node 104 (FIG. 1), e.g., as described above.

As indicated at block 304, the method may include communicating between the cellular node and the UE a measurement control message to schedule the WLAN measurements. For example, node 104 (FIG. 1) may transmit measurement control message 212 (FIG. 2) to UE 102 (FIG. 1), e.g., as described above.

As indicated at block 306, the method may include communicating between the UE and the cellular node a measurement report including WLAN measurement information. For example, UE 102 (FIG. 1) may transmit measurement report 216 (FIG. 2) to node 104 (FIG. 1), e.g., as described above.

As indicated at block 308, the method may include controlling offloading of the UE to a WLAN. For example, RNC 183 (FIG. 1) may control node 104 to transmit trigger message 220 (FIG. 2) to UE 102 (FIG. 1), e.g., as described above.

As indicated at block 310, the method may include transmitting UE-assistance information based on the measurement report. For example, RNC 183 (FIG. 1) may control node 104 to transmit UE-assistance information 224 (FIG. 2) to UE 102 (FIG. 1) and/or to one or more other UEs, e.g., as described above.

Reference is made to FIG. 4, which schematically illustrates a product of manufacture 400, in accordance with some demonstrative embodiments. Product 400 may include a non-transitory machine-readable storage medium 402 to store logic 404, which may be used, for example, to perform at least part of the functionality of RNC 183 (FIG. 1), UE 102 (FIG. 1), node 104 (FIG. 1), AP 106 (FIG. 1), controller 184 (FIG. 1), controller 144 (FIG. 1), wireless communication unit 110 (FIG. 1), and/or wireless communication unit 130 (FIG. 1), to perform one or more operations of the procedures of FIG. 2, and/or to perform one or more operations of the method of FIG. 3. The phrase “non-transitory machine-readable medium” is directed to include all computer-readable media, with the sole exception being a transitory propagating signal.

In some demonstrative embodiments, product 400 and/or machine-readable storage medium 402 may include one or more types of computer-readable storage media capable of storing data, including volatile memory, non-volatile memory, removable or non-removable memory, erasable or non-erasable memory, writeable or re-writeable memory, and the like. For example, machine-readable storage medium 402 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 404 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 404 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### Examples

The following examples pertain to further embodiments.

Example 1 includes a node B comprising a radio to communicate with a User Equipment (UE) over a cellular link; an Interface Unit b (Iub) to communicate with a Radio Network Controller (RNC), the Iub to receive from the RNC a trigger indication to indicate the UE is to initiate or terminate offloading to a Wireless Local Area Network (WLAN); and a controller to control the radio to transmit a trigger message to the UE based on the trigger indication.

Example 2 includes the subject matter of Example 1, and optionally, wherein the trigger message comprises one or more WLAN identifiers to identify one or more WLANs.

Example 3 includes the subject matter of Example 1 or 2, and optionally, wherein the trigger message comprises a handover Radio Resource Control (RRC) message.

Example 4 includes the subject matter of Example 1 or 2, and optionally, wherein the trigger message comprises a Radio Resource Control (RRC) connection release message or a RRC connection reject message.

Example 5 includes the subject matter of Example 1 or 2, and optionally, wherein the trigger message comprises a Handover from Universal Terrestrial Radio Access Network (UTRAN) command or a handover to UTRAN Command.

Example 6 includes the subject matter of any one of Examples 1-5, and optionally, wherein the Iub is to receive the trigger indication according to a Node-B Application Part (NBAP) signaling protocol.

Example 7 includes a node B comprising a radio to communicate with a User Equipment (UE) over a cellular link; an Interface Unit b (Iub) to communicate with a Radio Network Controller (RNC), the Iub to receive from the RNC scheduling information defining measurements corresponding to at least one Wireless Local Area Network (WLAN); and a controller to control the radio to transmit to the UE a measurement control message to schedule the measurements based on the scheduling information.

Example 8 includes the subject matter of Example 7, and optionally, wherein the measurement control message comprises at least one parameter selected from the group consisting of at least one identifier of the at least one WLAN, at least one frequency band of the at least one WLAN, and at least one frequency channel of the at least one WLAN.

Example 9 includes the subject matter of Example 8, and optionally, wherein the at least one identifier comprises at least one identifier selected from the group consisting of a Service Set Identification (SSID), an Extended SSID (ESSID), a Basic SSID (SSID), a Roaming Consortium, a Hotspot Operator Friendly Name, a Network Access Identifier (NAI) Home Realm, and a Mobility Domain.

Example 10 includes the subject matter of any one of Examples 7-9, and optionally, wherein the radio is to transmit a System Information Block (SIB) including the measurement control message.

Example 11 includes the subject matter of any one of Examples 7-9, and optionally, wherein the radio is to transmit a Radio Resource Control (RRC) message including the measurement control message.

Example 12 includes the subject matter of any one of Examples 7-11, and optionally, wherein the Iub is to receive from the RNC a system information update request including the scheduling information.

Example 13 includes the subject matter of any one of Examples 7-12, and optionally, wherein the radio is to receive from the UE a measurement report including WLAN measurement information corresponding to the WLAN, and wherein the controller is to control the Iub to send to the RNC an update report based on the WLAN measurement information.

Example 14 includes the subject matter of Example 13, and optionally, wherein the Iub is to send to the RNC a system information update response including the update report.

Example 15 includes the subject matter of Example 13 or 14, and optionally, wherein the measurement report comprises at least one parameter selected from the group consisting of an identifier of the WLAN, a channel of the WLAN, a privacy parameter of the WLAN, a security parameter of the WLAN, a Received Signal Strength Indicator (RSSI) of the WLAN, a Received Channel Power Indicator (RCPI) of the WLAN, a Received Power Indicator (RPI) of the WLAN, a Received Signal to Noise Indicator (RSNI) threshold of the WLAN, a connection Quality of Service (QoS) of the WLAN, a load parameter indicating a load of the WLAN, and an indication of one or more other WLANs detected by the UE.

Example 16 includes the subject matter of any one of Examples 13-15, and optionally, wherein the radio is to receive from the UE a Radio-Resource Control (RRC) signaling message including the measurement report.

Example 17 includes a Radio Network Controller (RNC) comprising an Interface Unit b (Iub) to communicate with a Node B; and a controller to control the Iub to send to the Node B a trigger indication to indicate a User Equipment (UE) connected to the Node B is to be triggered to initiate or terminate offloading to a Wireless Local Area Network (WLAN).

Example 18 includes the subject matter of Example 17, and optionally, wherein the controller is to determine whether the is to be triggered to initiate or terminate the offloading based on WLAN measurement information corresponding to the WLAN.

Example 19 includes the subject matter of Example 18, and optionally, wherein the WLAN measurement information comprises information measured by the UE.

Example 20 includes the subject matter of Example 18 or 19, and optionally, wherein the Iub is to receive the WLAN measurement information from the Node B.

Example 21 includes the subject matter of any one of Examples 18-20, and optionally, wherein the WLAN measurement information comprises at least one parameter selected from the group consisting of an identifier of the WLAN, a channel of the WLAN, a privacy parameter of the WLAN, a security parameter of the WLAN, a Received Signal Strength Indicator (RSSI) of the WLAN, a Received Channel Power Indicator (RCPI) of the WLAN, a Received Power Indicator (RPI) of the WLAN, a Received Signal to Noise Indicator (RSNI) threshold of the WLAN, a connection Quality of Service (QoS) of the WLAN, a load parameter indicating a load of the WLAN, and an indication of one or more other WLANs detected by the UE.

Example 22 includes the subject matter of any one of Examples 17-21, and optionally, wherein the controller is to control the Iub to send to the Node B scheduling information defining measurements to be performed by the UE with respect to the WLAN, wherein the Iub is to receive from the Node B an update report based on WLAN measurement information from the UE, and wherein the controller is to determine whether the UE is to be triggered to initiate or terminate the offloading based on the update report.

Example 23 includes the subject matter of any one of Examples 17-22, and optionally, wherein the trigger indication comprises a WLAN identifier to identify the WLAN.

Example 24 includes the subject matter of any one of Examples 17-23, and optionally, comprising a Universal Mobile Telecommunications System (UMTS) RNC.

Example 25 includes a Radio Network Controller (RNC) comprising an Interface Unit b (Iub) to communicate with a plurality of Nodes B; and a controller to control the Iub to send to the Nodes B scheduling information defining measurements to be performed by a plurality of User Equipment (UE) connected to the Nodes B with respect to one or more Wireless Local Area Networks (WLANs).

Example 26 includes the subject matter of Example 25, and optionally, wherein the Iub is to receive from the Nodes B measurement reports including WLAN measurement information corresponding to the one or more WLANs.

Example 27 includes the subject matter of Example 26, and optionally, wherein the controller is to determine UE-assistance information corresponding to the one or more WLANs based on the WLAN measurement information.

Example 28 includes the subject matter of Example 27, and optionally, wherein the controller is to control the Iub to send to a Node B of the plurality of Nodes B an indication to transmit a message including the UE-assistance information to at least one UE connected to the Node B.

Example 29 includes the subject matter of Example 26, and optionally, wherein the controller is to determine, based on the WLAN measurement information, a UE of the plurality of UEs to initiate or terminate offload to a WLAN of the WLANs, and wherein the controller is to control the Iub to send to a Node B connected to the UE a trigger indication to indicate the UE is to initiate or terminate offload to the WLAN.

Example 30 includes the subject matter of any one of Examples 26-29, and optionally, wherein the Iub is to receive from the Nodes B System information Update Response messages including the measurement reports.

Example 31 includes the subject matter of any one of Examples 25-30, and optionally, wherein the Iub is to send to the Nodes B System information Update Request messages including the scheduling information.

Example 32 includes a User Equipment (UE) comprising a Wireless Local Area Network (WLAN) radio; a cellular radio to receive from a Node B a cellular communication message including an offloading trigger; and a controller to control access network selection of the UE with respect to a WLAN based on the offloading trigger.

Example 33 includes the subject matter of Example 32, and optionally, wherein the cellular communication message comprises one or more WLAN identifiers to identify one or more WLANs.

Example 34 includes the subject matter of Example 32 or 33, and optionally, wherein the cellular communication message comprises a handover Radio Resource Control (RRC) message.

Example 35 includes the subject matter of Example 32 or 33, and optionally, wherein the cellular communication message comprises a Radio Resource Control (RRC) connection release message or a RRC connection reject message.

Example 36 includes the subject matter of Example 32 or 33, and optionally, wherein the cellular communication message comprises a Handover from Universal Terrestrial Radio Access Network (UTRAN) command or a handover to UTRAN Command.

Example 37 includes the subject matter of any one of Examples 32-36, and optionally, wherein the cellular radio is to receive from the Node B a first offloading trigger indicating the UE is to connect to the WLAN, the controller is to control the UE to connect to the WLAN and to remain connected to the Node B, the cellular radio is to receive from the Node B a second offloading trigger indicating the UE is to terminate the connection to the WLAN, and the controller is to control the UE to disconnect from the WLAN.

Example 38 includes a User Equipment (UE) comprising a Wireless Local Area Network (WLAN) radio; a cellular radio to receive from a Node B a measurement control message defining measurements corresponding to at least one Wireless Local Area Network (WLAN); and a controller to control the WLAN radio to perform the measurements, and to control the cellular radio to transmit to the Node B a measurement report based on the measurements.

Example 39 includes the subject matter of Example 38, and optionally, wherein the measurement control message comprises at least one parameter selected from the group consisting of at least one identifier of the at least one WLAN, at least one frequency band of the at least one WLAN, and at least one frequency channel of the at least one WLAN.

Example 40 includes the subject matter of Example 39, and optionally, wherein the at least one identifier comprises at least one identifier selected from the group consisting of a Service Set Identification (SSID), an Extended SSID (ESSID), a Basic SSID (SSID), a Roaming Consortium, a Hotspot Operator Friendly Name, a Network Access Identifier (NAI) Home Realm, and a Mobility Domain.

Example 41 includes the subject matter of any one of Examples 38-40, and optionally, wherein the cellular radio is to receive a System Information Block (SIB) including the measurement control message.

Example 42 includes the subject matter of any one of Examples 38-40, and optionally, wherein the cellular radio is to receive a Radio Resource Control (RRC) message including the measurement control message.

Example 43 includes the subject matter of any one of Examples 38-42 wherein the measurement report comprises at least one parameter selected from the group consisting of an identifier of the WLAN, a channel of the WLAN, a privacy parameter of the WLAN, a security parameter of the WLAN, a Received Signal Strength Indicator (RSSI) of the WLAN, a Received Channel Power Indicator (RCPI) of the WLAN, a Received Power Indicator (RPI) of the WLAN, a Received Signal to Noise Indicator (RSNI) threshold of the WLAN, a connection Quality of Service (QoS) of the WLAN, a load parameter indicating a load of the WLAN, and an indication of one or more other WLANs detected by the UE.

Example 44 includes the subject matter of any one of Examples 38-43, and optionally, wherein the cellular radio is to transmit to the node B a Radio-Resource Control (RRC) signaling message including the measurement report.

Example 45 includes the subject matter of any one of Examples 38-44, and optionally, wherein the cellular radio is to receive from the Node B UE-assistance information corresponding to one or more WLANs, and wherein the controller is to control access network selection of the UE based on the UE-assistance information.

Example 46 includes a Radio Network Controller (RNC) comprising an Interface Unit b (Iub) to communicate with a plurality of Nodes B; and a controller to control the Iub to send to the Nodes B scheduling information defining measurements to be performed by a plurality of User Equipment (UE) connected to the Nodes B with respect to one or more Wireless Local Area Networks (WLANs), wherein the Iub is to receive from the Nodes B measurement reports including WLAN measurement information corresponding to the one or more WLANs, and wherein the controller is to determine UE-assistance information corresponding to the one or more WLANs based on the WLAN measurement information, and to control the Iub to send to a Node B of the plurality of Nodes B an indication to transmit a message including the UE-assistance information to at least one UE connected to the Node B.

Example 47 includes the subject matter of Example 46, and optionally, wherein the controller is to determine, based on the WLAN measurement information, a UE of the plurality of UEs to initiate or terminate offload to a WLAN of the WLANs, and wherein the controller is to control the Iub to send to a Node B connected to the UE a trigger indication to indicate the UE is to initiate or terminate offload to the WLAN.

Example 48 includes the subject matter of Example 46 or 47, and optionally, wherein the Iub is to receive from the Nodes B System information Update Response messages including the measurement reports.

Example 49 includes the subject matter of any one of Examples 46-48, and optionally, wherein the Iub is to send to the Nodes B System information Update Request messages including the scheduling information.

Example 50 includes a method of triggering an offloading operation of a User Equipment (UE), the method comprising receiving at a node B a trigger indication from a Radio Network Controller (RNC) via a Node-B Application Part (NBAP) signaling protocol, the trigger indication to indicate the UE is to initiate or terminate offloading to a Wireless Local Area Network (WLAN); and transmitting a trigger message to the UE based on the trigger indication.

Example 51 includes the subject matter of Example 50, and optionally, wherein the trigger message comprises one or more WLAN identifiers to identify one or more WLANs.

Example 52 includes the subject matter of Example 50 or 51, and optionally, wherein the trigger message comprises a handover Radio Resource Control (RRC) message.

Example 53 includes the subject matter of Example 50 or 51, and optionally, wherein the trigger message comprises a Radio Resource Control (RRC) connection release message or a RRC connection reject message.

Example 54 includes the subject matter of Example 50 or 51, and optionally, wherein the trigger message comprises a Handover from Universal Terrestrial Radio Access Network (UTRAN) command or a handover to UTRAN Command.

Example 55 includes a method of communicating Wireless Local Area Network (WLAN) information to a Universal Mobile Telecommunications System (UMTS), the method comprising receiving at a node B scheduling information from a Radio Network Controller (RNC) via a Node-B Application Part (NBAP) signaling protocol, the scheduling information defining measurements corresponding to at least one WLAN; transmitting from the node B to a UE a measurement control message to schedule the measurements based on the scheduling information; receiving at the node B a measurement report from the UE, the measurement report including WLAN measurement information corresponding to the WLAN; and sending from the node B to the RNC an update report based on the WLAN measurement information.

Example 56 includes the subject matter of Example 55, and optionally, wherein the measurement control message comprises at least one parameter selected from the group consisting of at least one identifier of the at least one WLAN, at least one frequency band of the at least one WLAN, and at least one frequency channel of the at least one WLAN.

Example 57 includes the subject matter of Example 56, and optionally, wherein the at least one identifier comprises at least one identifier selected from the group consisting of a Service Set Identification (SSID), an Extended SSID (ESSID), a Basic SSID (SSID), a Roaming Consortium, a Hotspot Operator Friendly Name, a Network Access Identifier (NAI) Home Realm, and a Mobility Domain.

Example 58 includes the subject matter of any one of Examples 55-57, and optionally, comprising transmitting a System Information Block (SIB) including the measurement control message.

Example 59 includes the subject matter of any one of Examples 55-57, and optionally, comprising transmitting a Radio Resource Control (RRC) message including the measurement control message.

Example 60 includes the subject matter of any one of Examples 55-59, and optionally, comprising receiving from the RNC a system information update request including the scheduling information.

Example 61 includes the subject matter of any one of Examples 55-60, and optionally, comprising sending to the RNC a system information update response including the update report.

Example 62 includes the subject matter of any one of Examples 55-61, and optionally, wherein the measurement report comprises at least one parameter selected from the group consisting of an identifier of the WLAN, a channel of the WLAN, a privacy parameter of the WLAN, a security parameter of the WLAN, a Received Signal Strength Indicator (RSSI) of the WLAN, a Received Channel Power Indicator (RCPI) of the WLAN, a Received Power Indicator (RPI) of the WLAN, a Received Signal to Noise Indicator (RSNI) threshold of the WLAN, a connection Quality of Service (QoS) of the WLAN, a load parameter indicating a load of the WLAN, and an indication of one or more other WLANs detected by the UE.

Example 63 includes the subject matter of any one of Examples 55-62, and optionally, comprising receiving from the UE a Radio-Resource Control (RRC) signaling message including the measurement report.

Example 64 includes a method of triggering Wireless Local Area Network (WLAN) offloading at a Universal Mobile Telecommunications System (UMTS), the method comprising receiving at a Radio network Controller (RNC) of the UMTS WLAN measurement information corresponding to a WLAN; determining at the RNC a User Equipment (UE) to be triggered to initiate or terminate offloading to the WLAN, based on the WLAN measurement information; and sending a trigger indication from the RNC to a node B connected to the UE, the trigger message to indicate the UE is to be triggered to initiate or terminate offloading to the WLAN.

Example 65 includes the subject matter of Example 64, and optionally, wherein the WLAN measurement information comprises information measured by the UE.

Example 66 includes the subject matter of Example 64 or 65, and optionally, comprising receiving the WLAN measurement information from the node B.

Example 67 includes the subject matter of any one of Examples 64-66, and optionally, wherein the WLAN measurement information comprises at least one parameter selected from the group consisting of an identifier of the WLAN, a channel of the WLAN, a privacy parameter of the WLAN, a security parameter of the WLAN, a Received Signal Strength Indicator (RSSI) of the WLAN, a Received Channel Power Indicator (RCPI) of the WLAN, a Received Power Indicator (RPI) of the WLAN, a Received Signal to Noise Indicator (RSNI) threshold of the WLAN, a connection Quality of Service (QoS) of the WLAN, a load parameter indicating a load of the WLAN, and an indication of one or more other WLANs detected by the UE.

Example 68 includes the subject matter of any one of Examples 64-67, and optionally, comprising sending to the node B scheduling information defining measurements to be performed by the UE with respect to the WLAN, receiving from the node B an update report based on WLAN measurement information from the UE, and determine whether the UE is to be triggered to initiate or terminate the offloading based on the update report.

Example 69 includes the subject matter of any one of Examples 64-68, and optionally, wherein the trigger indication comprises a WLAN identifier to identify the WLAN.

Example 70 includes a method of communicating Wireless Local Area Network (WLAN) information to a Universal Mobile Telecommunications System (UMTS), the method comprising sending from a Radio Network Controller (RNC) to a plurality of nodes B scheduling information defining measurements to be performed by a plurality of User Equipment (UE) connected to the Nodes B with respect to one or more WLANs; receiving at the RNC measurement reports from the nodes B, the measurement reports including WLAN measurement information corresponding to the one or more WLANs; determining UE-assistance information corresponding to the one or more WLANs based on the WLAN measurement information; and sending to a Node B of the plurality of Nodes B an indication to transmit a message including the UE-assistance information to at least one UE connected to the Node B.

Example 71 includes the subject matter of Example 70, and optionally, comprising identifying, based on the WLAN measurement information, an identified UE of the plurality of UEs to initiate or terminate offload to a WLAN of the WLANs, and sending to a Node B connected to the identified UE a trigger indication to indicate the identified UE is to initiate or terminate offload to the WLAN.

Example 72 includes the subject matter of Example 70 or 71, and optionally, comprising receiving from the nodes B System information Update Response messages including the measurement reports.

Example 73 includes the subject matter of any one of Examples 70-72, and optionally, comprising sending to the nodes B System information Update Request messages including the scheduling information.

Example 74 includes a product including a non-transitory storage medium having stored thereon instructions that, when executed by a machine, result in receiving at a node B a trigger indication from a Radio Network Controller (RNC) via a Node-B Application Part (NBAP) signaling protocol, the trigger indication to indicate a User Equipment (UE) is to initiate or terminate offloading to a Wireless Local Area Network (WLAN); and transmitting a trigger message to the UE based on the trigger indication.

Example 75 includes the subject matter of Example 74, and optionally, wherein the trigger message comprises one or more WLAN identifiers to identify one or more WLANs.

Example 76 includes the subject matter of Example 74 or 75, and optionally, wherein the trigger message comprises a handover Radio Resource Control (RRC) message.

Example 77 includes the subject matter of Example 74 or 75, and optionally, wherein the trigger message comprises a Radio Resource Control (RRC) connection release message or a RRC connection reject message.

Example 78 includes the subject matter of Example 74 or 75, and optionally, wherein the trigger message comprises a Handover from Universal Terrestrial Radio Access Network (UTRAN) command or a handover to UTRAN Command.

Example 79 includes a product including a non-transitory storage medium having stored thereon instructions that, when executed by a machine, result in receiving at a node B scheduling information from a Radio Network Controller (RNC) via a Node-B Application Part (NBAP) signaling protocol, the scheduling information defining measurements corresponding to at least one Wireless Local Area Network (WLAN); transmitting from the node B to a UE a measurement control message to schedule the measurements based on the scheduling information; receiving at the node B a measurement report from the UE, the measurement report including WLAN measurement information corresponding to the WLAN; and sending from the node B to the RNC an update report based on the WLAN measurement information.

Example 80 includes the subject matter of Example 79, and optionally, wherein the measurement control message comprises at least one parameter selected from the group consisting of at least one identifier of the at least one WLAN, at least one frequency band of the at least one WLAN, and at least one frequency channel of the at least one WLAN.

Example 81 includes the subject matter of Example 80, and optionally, wherein the at least one identifier comprises at least one identifier selected from the group consisting of a Service Set Identification (SSID), an Extended SSID (ESSID), a Basic SSID (SSID), a Roaming Consortium, a Hotspot Operator Friendly Name, a Network Access Identifier (NAI) Home Realm, and a Mobility Domain.

Example 82 includes the subject matter of any one of Examples 79-81, and optionally, wherein the instructions result in transmitting a System Information Block (SIB) including the measurement control message.

Example 83 includes the subject matter of any one of Examples 79-81, and optionally, wherein the instructions result in transmitting a Radio Resource Control (RRC) message including the measurement control message.

Example 84 includes the subject matter of any one of Examples 79-83, and optionally, wherein the instructions result in receiving from the RNC a system information update request including the scheduling information.

Example 85 includes the subject matter of any one of Examples 79-84, and optionally, wherein the instructions result in sending to the RNC a system information update response including the update report.

Example 86 includes the subject matter of any one of Examples 79-85, and optionally, wherein the measurement report comprises at least one parameter selected from the group consisting of an identifier of the WLAN, a channel of the WLAN, a privacy parameter of the WLAN, a security parameter of the WLAN, a Received Signal Strength Indicator (RSSI) of the WLAN, a Received Channel Power Indicator (RCPI) of the WLAN, a Received Power Indicator (RPI) of the WLAN, a Received Signal to Noise Indicator (RSNI) threshold of the WLAN, a connection Quality of Service (QoS) of the WLAN, a load parameter indicating a load of the WLAN, and an indication of one or more other WLANs detected by the UE.

Example 87 includes the subject matter of any one of Examples 79-86, and optionally, wherein the instructions result in receiving from the UE a Radio-Resource Control (RRC) signaling message including the measurement report.

Example 88 includes a product including a non-transitory storage medium having stored thereon instructions that, when executed by a machine, result in receiving at a Radio network Controller (RNC) Wireless Local Area Network (WLAN) measurement information corresponding to a WLAN; determining at the RNC a User Equipment (UE) to be triggered to initiate or terminate offloading to the WLAN, based on the WLAN measurement information; and sending a trigger indication from the RNC to a node B connected to the UE, the trigger message to indicate the UE is to be triggered to initiate or terminate offloading to the WLAN.

Example 89 includes the subject matter of Example 88, and optionally, wherein the WLAN measurement information comprises information measured by the UE.

Example 90 includes the subject matter of Example 88 or 89, and optionally, wherein the instructions result in receiving the WLAN measurement information from the node B.

Example 91 includes the subject matter of any one of Examples 88-90, and optionally, wherein the WLAN measurement information comprises at least one parameter selected from the group consisting of an identifier of the WLAN, a channel of the WLAN, a privacy parameter of the WLAN, a security parameter of the WLAN, a Received Signal

Strength Indicator (RSSI) of the WLAN, a Received Channel Power Indicator (RCPI) of the WLAN, a Received Power Indicator (RPI) of the WLAN, a Received Signal to Noise Indicator (RSNI) threshold of the WLAN, a connection Quality of Service (QoS) of the WLAN, a load parameter indicating a load of the WLAN, and an indication of one or more other WLANs detected by the UE.

Example 92 includes the subject matter of any one of Examples 88-91, and optionally, wherein the instructions result in sending to the node B scheduling information defining measurements to be performed by the UE with respect to the WLAN, receiving from the node B an update report based on WLAN measurement information from the UE, and determine whether the UE is to be triggered to initiate or terminate the offloading based on the update report.

Example 93 includes the subject matter of any one of Examples 88-92, and optionally, wherein the trigger indication comprises a WLAN identifier to identify the WLAN.

Example 94 includes a product including a non-transitory storage medium having stored thereon instructions that, when executed by a machine, result in sending from a Radio Network Controller (RNC) to a plurality of nodes B scheduling information defining measurements to be performed by a plurality of User Equipment (UE) connected to the Nodes B with respect to one or more Wireless Local Area Networks (WLANs); receiving at the RNC measurement reports from the nodes B, the measurement reports including WLAN measurement information corresponding to the one or more WLANs; determining UE-assistance information corresponding to the one or more WLANs based on the WLAN measurement information; and sending to a Node B of the plurality of Nodes B an indication to transmit a message including the UE-assistance information to at least one UE connected to the Node B.

Example 95 includes the subject matter of Example 94, and optionally, wherein the instructions result in identifying, based on the WLAN measurement information, an identified UE of the plurality of UEs to initiate or terminate offload to a WLAN of the WLANs, and sending to a Node B connected to the identified UE a trigger indication to indicate the identified UE is to initiate or terminate offload to the WLAN.

Example 96 includes the subject matter of Example 94 or 95, and optionally, wherein the instructions result in receiving from the nodes B System information Update Response messages including the measurement reports.

Example 97 includes the subject matter of any one of Examples 94-96, and optionally, wherein the instructions result in sending to the nodes B System information Update Request messages including the scheduling information.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1.-23. (canceled)

24. A node B comprising:
a radio to communicate with a User Equipment (UE) over a cellular link;
an Interface Unit b (Iub) to communicate with a Radio Network Controller (RNC), said Iub to receive from said RNC a trigger indication to indicate said UE is to initiate or terminate offloading to a Wireless Local Area Network (WLAN); and
a controller to control said radio to transmit a trigger message to said UE based on said trigger indication.

25. The node B of claim 24, wherein said trigger message comprises one or more WLAN identifiers to identify one or more WLANs.

26. The node B of claim 24, wherein said trigger message comprises a handover Radio Resource Control (RRC) message.

27. The node B of claim 24, wherein said trigger message comprises a Radio Resource Control (RRC) connection release message or a RRC connection reject message.

28. The node B of claim 24, wherein said trigger message comprises a Handover from Universal Terrestrial Radio Access Network (UTRAN) command or a handover to UTRAN Command.

29. The node B of claim 24, wherein said Iub is to receive said trigger indication according to a Node-B Application Part (NBAP) signaling protocol.

30. A User Equipment (UE) comprising:
a Wireless Local Area Network (WLAN) radio;
a cellular radio to receive from a Node B a measurement control message defining measurements corresponding to at least one Wireless Local Area Network (WLAN); and
a controller to control said WLAN radio to perform said measurements, and to control said cellular radio to transmit to said Node B a measurement report based on said measurements.

31. The UE of claim 30, wherein said measurement control message comprises at least one parameter selected from the group consisting of at least one identifier of said at least one WLAN, at least one frequency band of said at least one WLAN, and at least one frequency channel of said at least one WLAN.

32. The UE of claim 30, wherein said at least one identifier comprises at least one identifier selected from the group consisting of a Service Set Identification (SSID), an Extended SSID (ESSID), a Basic SSID (SSID), a Roaming Consortium, a Hotspot Operator Friendly Name, a Network Access Identifier (NAI) Home Realm, and a Mobility Domain.

33. The UE of claim 30, wherein said cellular radio is to receive a System Information Block (SIB) including said measurement control message.

34. The UE of claim 30, wherein said cellular radio is to receive a Radio Resource Control (RRC) message including said measurement control message.

35. The UE of claim 30, wherein said measurement report comprises at least one parameter selected from the group consisting of an identifier of said WLAN, a channel of said WLAN, a privacy parameter of said WLAN, a security parameter of said WLAN, a Received Signal Strength Indicator (RSSI) of said WLAN, a Received Channel Power Indicator (RCPI) of said WLAN, a Received Power Indicator (RPI) of said WLAN, a Received Signal to Noise Indicator (RSNI) threshold of said WLAN, a connection Quality of Service (QoS) of said WLAN, a load parameter indicating a load of said WLAN, and an indication of one or more other WLANs detected by said UE.

36. The UE of claim 30, wherein said cellular radio is to receive from said Node B UE-assistance information corresponding to one or more WLANs, and wherein said controller is to control access network selection of said UE based on said UE-assistance information.

37. A Radio Network Controller (RNC) comprising:
an Interface Unit b (Iub) to communicate with a plurality of Nodes B; and
a controller to control said Iub to send to said Nodes B scheduling information defining measurements to be performed by a plurality of User Equipment (UE) connected to said Nodes B with respect to one or more Wireless Local Area Networks (WLANs),
wherein said Iub is to receive from said Nodes B measurement reports including WLAN measurement information corresponding to said one or more WLANs,
and wherein said controller is to determine UE-assistance information corresponding to said one or more WLANs based on said WLAN measurement information, and to control said Iub to send to a Node B of said plurality of Nodes B an indication to transmit a message including said UE-assistance information to at least one UE connected to said Node B.

38. The RNC of claim 37, wherein said controller is to determine, based on said WLAN measurement information, a UE of said plurality of UEs to initiate or terminate offload to a WLAN of said WLANs, and wherein said controller is to control said Iub to send to a Node B connected to said UE a trigger indication to indicate said UE is to initiate or terminate offload to said WLAN.

39. The RNC of claim 37, wherein said Iub is to receive from said Nodes B System information Update Response messages including said measurement reports.

40. The RNC of claim 37, wherein said Iub is to send to said Nodes B System information Update Request messages including said scheduling information.

41. A product including a non-transitory storage medium having stored thereon instructions that, when executed by a machine, result in:
receiving at a node B scheduling information from a Radio Network Controller (RNC) via a Node-B Application Part (NBAP) signaling protocol, said scheduling information defining measurements corresponding to at least one Wireless Local Area Network (WLAN);
transmitting from said node B to a UE a measurement control message to schedule said measurements based on said scheduling information;
receiving at said node B a measurement report from said UE, the measurement report including WLAN measurement information corresponding to said WLAN; and
sending from said node B to said RNC an update report based on the WLAN measurement information.

42. The product of claim 41, wherein said measurement control message comprises at least one parameter selected from the group consisting of at least one identifier of said at least one WLAN, at least one frequency band of said at least one WLAN, and at least one frequency channel of said at least one WLAN.

43. The product of claim 41, wherein said instructions result in transmitting a System Information Block (SIB) including said measurement control message.

44. The product of claim 41, wherein said instructions result in transmitting a Radio Resource Control (RRC) message including said measurement control message.

45. The product of claim 41, wherein said instructions result in receiving from said RNC a system information update request including said scheduling information.

46. The product of claim 41, wherein said instructions result in sending to said RNC a system information update response including said update report.

47. The product of claim 41, wherein said measurement report comprises at least one parameter selected from the group consisting of an identifier of said WLAN, a channel of said WLAN, a privacy parameter of said WLAN, a security parameter of said WLAN, a Received Signal Strength Indicator (RSSI) of said WLAN, a Received Channel Power Indicator (RCPI) of said WLAN, a Received Power Indicator (RPI) of said WLAN, a Received Signal to Noise Indicator (RSNI) threshold of said WLAN, a connection Quality of Service (QoS) of said WLAN, a load parameter indicating a load of said WLAN, and an indication of one or more other WLANs detected by said UE.

48. The product of claim 41, wherein said instructions result in receiving from said UE a Radio-Resource Control (RRC) signaling message including said measurement report.
